(19) United States
(12) Patent Application Publication
(10) Pub. No.: US 2022/0029764 A1
(43) Pub. Date: Jan. 27, 2022

(54) WIRELESS COMMUNICATION METHOD AND USER EQUIPMENT FOR SOUNDING REFERENCE SIGNAL RESOURCES

(71) Applicant: FG Innovation Company Limited, Tuen Mun (HK)

(72) Inventors: JIA-HONG LIOU, Taipei (TW); CHIA-HAO YU, Taipei (TW)

(21) Appl. No.: 17/379,352

(22) Filed: Jul. 19, 2021

Related U.S. Application Data
(60) Provisional application No. 63/053,487, filed on Jul. 17, 2020.

(51) Int. Cl. H04L 5/00

(52) U.S. Cl. CPC H04L 5/0048; H04L 5/0094

(57) ABSTRACT

A wireless communication method, performed by a User Equipment (UE) for Sounding Reference Signal (SRS) resources, comprises receiving at least one configuration for one or more SRS resource sets; receiving a Medium Access Control (MAC) Control Element (CE) indicating a SRS resource set of the one or more SRS resource sets; determining whether at least one first field and at least one second field of the MAC CE are present; deriving at least one spatial relation by using the at least one first field and the at least one second field if the at least one first field and the at least one second field are present; and transmitting at least one SRS resource among the SRS resource set via the at least one corresponding spatial relation, wherein the at least one first field and the at least one second field of the MAC CE are present at least when the SRS resource set is an aperiodic SRS resource set.

### CROSS-REFERENCE TO RELATED APPLICATION(S)

The present disclosure claims the benefit of and priority to provisional U.S. Patent Application Ser. No. 63/053,487 (“the '487 provisional”), filed on Jul. 17, 2020, entitled “METHOD AND APPARATUS FOR INDICATING SRS-RELATED INFORMATION IN A WIRELESS COMMUNICATION SYSTEM”. The contents of the '487 provisional are fully incorporated herein by reference for all purposes.

### FIELD

The present disclosure is generally related to wireless communications, and specifically, to a wireless communication method and a user equipment for Sounding Reference Signal (SRS) resources.

### BACKGROUND

With the tremendous growth in the number of connected devices and the rapid increase in user/Network (NW) traffic volume, various efforts have been made to improve different aspects of wireless communication for the next-generation wireless communication system, such as the fifth-generation (5G) New Radio (NR), by improving data rate, latency, reliability, and mobility.

The 5G NR system is designed to provide flexibility and configurability to optimize the NW services and types, accommodating various use cases such as Enhanced Mobile Broadband (eMBB), Massive Machine-Type Communication (mMTC), and Ultra-Reliable and Low-Latency Communication (URLLC).

However, as the demand for radio access continues to increase, there is a need in the art to improve Sounding Reference Signal (SRS) resources.

### SUMMARY

The present disclosure is directed to methods and user equipment (UE) for Sounding Reference Signal (SRS) resources.

In a first aspect of the present application, a method performed by a User Equipment (UE) for Sounding Reference Signal (SRS) resources is provided. The method comprises receiving at least one configuration for one or more SRS resource sets; receiving a Medium Access Control (MAC) Control Element (CE) indicating an SRS resource set of the one or more SRS resource sets; determining whether at least one first field and at least one second field of the MAC CE are present; deriving at least one spatial relation by using the at least one first field and the at least one second field if the at least one first field and the at least one second field are present; and transmitting at least one SRS resource among the SRS resource set via the at least one corresponding spatial relation, wherein the at least one first field and the at least one second field of the MAC CE are present at least when the SRS resource set is an aperiodic SRS resource set.

In an implementation of the first aspect, each of the at least one first field indicates at least one resource index for deriving one spatial relation.

In another implementation of the first aspect, each of the at least one second field indicates at least one resource type for deriving one spatial relation.

In another implementation of the first aspect, a total number of the at least one SRS resource is the same as a total number of the at least one spatial relation.

In another implementation of the first aspect, a total number of the at least one SRS resource is the same as a total number of the at least one first field.

In another implementation of the first aspect, a total number of the at least one SRS resource is the same as a total number of the at least one second field.

Another implementation of the first aspect further comprises deriving an N-th element of the at least one spatial relation by using both an N-th element of the at least one first field and an N-th element of the at least one second field.

In another implementation of the first aspect, the at least one first field refers to a resource Identity (ID) field.

In another implementation of the first aspect, the at least one second field refers to a F field.

In a second aspect of the present application, a User Equipment (UE) in a wireless communication system for Sounding Reference Signal (SRS) resources is provided. The UE comprises a processor; and a memory coupled to the processor, wherein the memory stores a computer-executable program that, when executed by the processor, causes the processor to receive at least one configuration for one or more SRS resource sets; receive a Medium Access Control (MAC) Control Element (CE) indicating an SRS resource set of the one or more SRS resource sets; determine whether at least one first field and at least one second field of the MAC CE are present; derive at least one spatial relation by using the at least one first field and the at least one second field if the at least one first field and the at least one second field are present; and transmit at least one SRS resource among the SRS resource set via the at least one corresponding spatial relation, wherein the at least one first field and the at least one second field of the MAC CE are present at least when the SRS resource set is an aperiodic SRS resource set.

### BRIEF DESCRIPTION OF THE DRAWINGS

Aspects of the present disclosure are best understood from the following when read with the accompanying figures. Various features are not drawn to scale. Dimensions of various features may be arbitrarily increased or reduced for clarity of discussion.

FIG. 1 illustrates an overview of a transmitter block diagram for Cyclic Prefix-Orthogonal Frequency Division Multiplexing (CP-OFDM) with optional Discrete Fourier Transform spreading according to an example implementation of the present disclosure.

FIG. 2 illustrates an overview of Uplink-Downlink (UL-DL) timing relation according to an example implementation of the present disclosure.

FIG. 3 illustrates an overview of time-frequency structure of an SSB according to an example implementation of the present disclosure.

FIG. 4 illustrates an overview of a Semi-Persistent Sounding Reference Signal (SP SRS)Activation/Deactivation MAC CE according to an example implementation of the present disclosure.

FIG. 5 illustrates an Enhanced SP/Aperiodic (AP) spatial relation Indication MAC CE according to an example implementation of the present disclosure.

FIG. 6 illustrates a SP Positioning SRS Activation/Deactivation MAC CE according to an example implementation of the present disclosure.

FIG. 7A to 7D illustrate different Spatial Relations for Resource IDᵢ according to example implementations of the present disclosure.

FIGS. 8A and 8B illustrate different UE states and transitions according to example implementations of the present disclosure.

FIG. 9 illustrates an overview of the MAC-CE according to an example implementation of the present disclosure.

FIG. 10 illustrates a procedure for SRS resource transmission performed by a UE according to an implementation of the present disclosure.

FIG. 11 illustrates a block diagram of a node for wireless communication according to an implementation of the present disclosure.

### DESCRIPTION

The acronyms in the present disclosure are defined as follows. Unless otherwise specified, the acronyms have the following meanings.

| Acronym | Full name |
|---|---|
| 3GPP | 3rd Generation Partnership Project |
| 5G | 5th Generation |
| 5G-S-TMSI | 5th Generation S-Temporary Mobile Subscriber Identity |
| ACK | Acknowledgement |
| AP | Aperiodic |
| AS | Access Stratum |
| BPSK | Binary Phase-Shift Keying |
| BS | Base Station |
| BWP | Bandwidth Part |
| CA | Carrier Aggregation |
| CC | Component Carrier |
| CCE | Control Channel Element |
| CE | Control Element |
| CLI | Cross Link Interference |
| CN | Core Network |
| CORESET | Control Resource Set |
| CP | Cyclic Prefix |
| CRC | Cyclic Redundancy Check |
| CSI | Channel State Information |
| CSI-RS | Channel State Information based Reference Signal |
| DCI | Downlink Control Information |
| DFT | Discrete Fourier Transform |
| DL | Downlink |
| DMRS | Demodulation Reference Signal |
| DRX | Discontinuous Reception |
| EDT | Early Data Transmission |
| eNB | evolved Node B |
| EDGE | Enhanced Data rates for GSM Evolution |
| E-UTRA | Evolved Universal Terrestrial Radio Access |
| FDD | Frequency Division Duplexing |
| gNB | g Node B |
| HARQ | Hybrid Automatic Repeat request |
| ID | Identity |
| IE | Information Element |
| I-RNTI | Inactive Radio Network Temporary Identifier |
| LCID | Logical Channel Identification |
| LDPC | Low Density Parity Check |
| LTE | Long Term Evolution |
| MAC | Medium Access Control |
| MCG | Master Cell Group |
| MIB | Master Information Block |
| MU-MIMO | Multi-User Multiple Input Multiple Output |
| NACK | Negative Acknowledgement |
| NR | New RAT/Radio |
| NCGI | NR Cell Global Identifier |
| NUL | Normal Uplink |
| NW | Network |
| NZP | Non-Zero Power |
| OFDM | Orthogonal Frequency Division Modulation |
| PBCH | Physical Broadcast Channel |
| PCell | Primary Cell |
| PCI | Physical Cell Identity |
| PDCCH | Physical Downlink Control Channel |
| PDSCH | Physical Downlink Shared Channel |
| PDU | Packet Data Unit |
| PRACH | Physical Random Access Channel |
| P-RNTI | Paging Radio Network Temporary Identifier |
| PRS | Positioning Reference Signal |
| PRB | Physical Resource Block |
| PRG | Precoding Resource Block Group |
| PSCell | Primary Secondary Cell |
| PSS | Primary Synchronization Signal |
| PTRS | Phase Tracking Reference Signal |
| PUCCH | Physical Uplink Control Channel |
| PUSCH | Physical Uplink Shared Channel |
| PUR | Preconfigured UL Resource |
| QAM | Quadrature Amplitude Modulation |
| QPSK | Quadrature Phase Shift Keying |
| RA | Random Access |
| RACH | Random Access Channel |
| RAN | Radio Access Network |
| REG | Resource Element Group |
| Rel | Release |
| RMSI | Remaining Minimum System Information |
| RRC | Radio Resource Control |
| RRM | Radio Resource Management |
| RS | Reference Signal |
| RSRP | Reference Signal Received Power |
| RSRQ | Reference Signal Received Quality |
| RTT | Round Trip Time |
| RX | Reception |
| SCell | Secondary Cell |
| SCG | Secondary Cell Group |
| SCH | Shared Channel |
| SCS | Sub-Carrier Space |
| SFN | System Frame Number |
| SI | System Information |
| SIB | System Information Block |
| SINR | Signal to Interference plus Noise Ratio |
| SP | Semi-Persistent |
| SRS | Sounding Reference Signal |
| SRI | SRS Resource Indicator |
| SS | Synchronization Signal |
| SSS | Secondary Synchronization Signal |
| SSB | Synchronization Signal Block |
| SpCell | Special Cell |
| SU-MIMO | Single-User Multiple Input Multiple Output |
| SUL | Supplementary Uplink |
| TA | Timing Advance or Time Alignment |
| TAG | Time Alignment Group |
| TB | Transport Block |
| TCI | Transmission Configuration Indicator |
| TDD | Time Division Duplexing |
| TPC | Transmission Power Control |
| TRP | Transmission/Reception Point |
| TS | Technical Specification |
| TX | Transmission |
| UCI | Uplink Control Information |
| UE | User Equipment |
| UP | User Plane |
| UL | Uplink |
| UL-SCH | Uplink Shared Channel |

The following contains specific information pertaining to implementations of the present disclosure. The drawings and their accompanying detailed disclosure are directed to merely exemplary implementations. However, the present disclosure is not limited to these exemplary implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features are identified (although, in some examples, not illustrated) by numerals in the example figures. However, the features in different implementations may differ in other respects, and thus shall not be narrowly confined to what is illustrated in the figures.

References to “one implementation,” “an implementation,” “example implementation,” “various implementations,” “some implementations,” “implementations of the present disclosure,” etc., may indicate that the implementation(s) of the present disclosure may include a particular feature, structure, or characteristic, but not every possible implementation of the present disclosure necessarily includes the particular feature, structure, or characteristic. Further, repeated use of the phrase “in one implementation,” “in an example implementation,” or “an implementation,” do not necessarily refer to the same implementation, although they may. Moreover, any use of phrases like “implementations” in connection with “the present disclosure” are not meant to characterize that all implementations of the present disclosure must include the particular feature, structure, or characteristic, and should instead be understood to mean “at least some implementations of the present disclosure” includes the stated particular feature, structure, or characteristic.

The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-disclosed combination, group, series, and the equivalent.

The term “and/or” is only an association relationship for describing associated objects, and represents that three relationships may exist, for example, A and/or B may represent that: A exists alone, A and B exist at the same time, and B exists alone. “A and/or B and/or C” may represent that at least one of A, B and C exists. In addition, the character “/” generally represents that the former and latter associated objects are in an “or” relationship.

Additionally, for the purpose of non-limiting explanation, specific details, such as functional entities, techniques, protocols, standards, and the like, are set forth for providing an understanding of the disclosed technology. In other examples, a detailed disclosure of well-known methods, technologies, systems, architectures, and the like are omitted in order not to obscure the present disclosure with unnecessary details.

Persons skilled in the art will immediately recognize that any NW function(s) or algorithm(s) in the present disclosure may be implemented by hardware, software, or a combination of software and hardware. Disclosed functions may correspond to modules that may be software, hardware, firmware, or any combination thereof. The software implementation may comprise computer-executable instructions stored on computer-readable media such as memory or other types of storage devices.

For example, one or more microprocessors or general-purpose computers with communication processing capability may be programmed with corresponding executable instructions and carry out the disclosed NW function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations in the present disclosure are directed to software installed and executing on computer hardware, alternative example implementations implemented as firmware or as hardware or combination of hardware and software are well within the scope of the present disclosure.

The computer-readable medium includes but is not limited to Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a LTE system, an LTE-Advanced (LTE-A) system, or an LTE-Advanced Pro system) typically includes at least one BS, at least one UE, and one or more optional NW elements that provide connection towards an NW. The UE communicates with the NW (e.g., a CN, an Evolved Packet Core (EPC) NW, an Evolved Universal Terrestrial Radio Access NW (E-UTRAN), a Next-Generation Core (NGC), a 5G Core Network (5GC), or an Internet), through a RAN established by the BS.

It should be noted that, in the present disclosure, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, or a Personal Digital Assistant (PDA) with wireless communication capability. The UE is configured to receive and transmit signals over an air interface to one or more cells in a RAN.

A BS may include, but not limited to, a Node B (NB) as in the Universal Mobile Telecommunication System (UMTS), an eNB as in the LTE-A, a Radio NW Controller (RNC) as in the UMTS, a Base Station Controller (BSC) as in the Global System for Mobile communications (GSM)/GSM EDGE Radio Access NW (GERAN), a Next Generation eNB (ng-eNB) as in an E-UTRA BS in connection with the 5GC, a gNB as in the 5G Access NW (5G-AN), and any other apparatus capable of controlling radio communication and managing radio resources within a cell. The BS may connect to serve the one or more UEs through a radio interface to the NW.

A BS may be configured to provide communication services according to at least one of the following Radio Access Technologies (RATs): Worldwide Interoperability for Microwave Access (WiMAX), GSM (often referred to as 2G), GERAN, General Packet Radio Service (GPRS), UMTS (often referred to as 3G) based on basic Wideband-Code Division Multiple Access (W-CDMA), High-Speed Packet Access (HSPA), LTE, LTE-A, enhanced LTE (eLTE), NR (often referred to as 5G), and LTE-A Pro. However, the scope of the present disclosure should not be limited to the protocols previously disclosed.

The BS may be operable to provide radio coverage to a specific geographical area using a plurality of cells included in the RAN. The BS may support the operations of the cells. Each cell is operable to provide services to at least one UE within its radio coverage. More specifically, each cell (often referred to as a serving cell) may provide services to serve one or more UEs within its radio coverage, (e.g., each cell schedules the DL and optionally UL resources to at least one UE within its radio coverage for DL and optionally UL packet transmissions). The BS may communicate with one or more UEs in the radio communication system through the plurality of cells. A cell may allocate sidelink (SL) resources for supporting proximity service (ProSe). Each cell may have overlapped coverage areas with other cells.

In Multi-RAT Dual Connectivity (MR-DC) cases, the primary cell of an MCG or a SCG may be called as a SpCell. A PCell may refer to the SpCell of an MCG. A PSCell may refer to the SpCell of an SCG. MCG refers to a group of serving cells associated with the Master Node (MN), comprising the SpCell and optionally one or more SCells. SCG refers to a group of serving cells associated with the Secondary Node (SN), comprising of the SpCell and optionally one or more SCells.

In some implementations, the UE may not have (LTE/NR) RRC connections with the concerned serving cells of the associated services. In other words, the UE may not have UE-specific RRC signalings exchange with the serving cell. Instead, the UE may only monitor the DL synchronization signals (e.g., DL synchronization burst sets) and/or broadcasting SI related to the concerned services from such serving cells. In addition, the UE may have at least one serving cell on one or more target SL frequency carriers for the associated services. In some other implementations, the UE may consider the RAN which configures one or more of the serving cells as a serving RAN.

As previously disclosed, the frame structure for NR supports flexible configurations for accommodating various next generation (e.g., 5G) communication requirements, such as eMBB, mMTC, and URLLC, while fulfilling high reliability, high data rate, and low latency requirements. The OFDM technology, as disclosed in 3GPP, may serve as a baseline for an NR waveform. The scalable OFDM numerology, such as the adaptive sub-carrier spacing, the channel bandwidth, and the CP, may also be used. Additionally, two coding schemes are considered for NR: (1) LDPC code and (2) polar code. The coding scheme adaption may be configured based on the channel conditions and/or service applications.

It is also considered that in a transmission time interval of a single NR frame, at least DL transmission data, a guard period, and UL transmission data should be included. The respective portions of the DL transmission data, the guard period, the UL transmission data should also be configurable, for example, based on the NW dynamics of NR. In addition, SL resources may also be provided in an NR frame to support ProSe services.

The following paragraphs related to Physical Layer may be implemented or performed by a terminal or a NW node.

Waveform, Numerology and Frame Structure

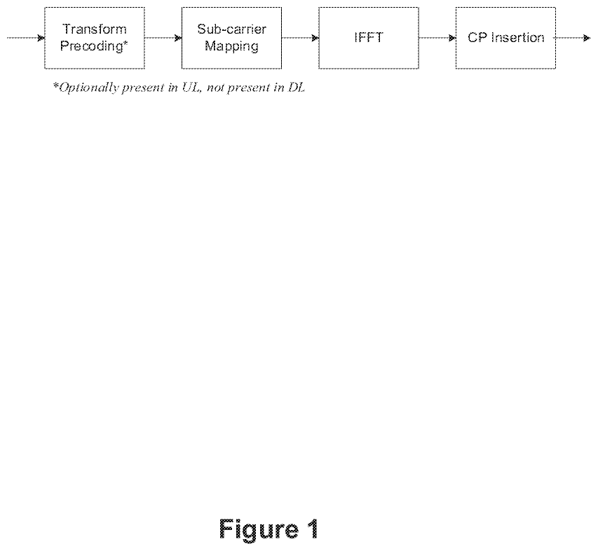

Please refer to FIG. 1, which illustrates an overview of a transmitter block diagram for CP-OFDM with optional DFT spreading according to an example implementation of the present disclosure. As shown in FIG. 1, the DL transmission waveform is an OFDM using a CP. The UL transmission waveform is conventional OFDM using a cyclic prefix with a transform precoding function performing DFT spreading that can be disabled or enabled. For operation with shared spectrum channel access, the UL transmission waveform subcarrier mapping can map to subcarriers in one or more PRB interlaces.

The numerology is based on exponentially scalable sub-carrier spacing Δf=2^{μ}×15 kHz with μ={0,1,3,4} for PSS, SSS and PBCH and μ={0,1,2,3} for other channels. Normal CP is supported for all sub-carrier spacings, Extended CP is supported for p=2. 12 consecutive sub-carriers form a PRB. Up to 275 PRBs are supported on a carrier. More details of supported transmission numerologies can be referred to Table 1.

TABLE 1

| | Δf = 2^{μ} · 15 | Cyclic | Supported for | Supported for |
|---|---|---|---|---|
| μ | [kHz] | prefix | data | synch |
| 0 | 15 | Normal | Yes | Yes |
| 1 | 30 | Normal | Yes | Yes |
| 2 | 60 | Normal, | Yes | No |
| | | Extended | | |
| 3 | 120 | Normal | Yes | Yes |
| 4 | 240 | Normal | No | Yes |

The UE may be configured with one or more bandwidth parts on a given CC, of which only one can be active at a time, as described in 3GPP TS 38.300 Rel-16 specification. The active BWP defines the UE's operating bandwidth within the cell's operating bandwidth. For initial access, and until the UE's configuration in a cell is received, initial bandwidth part detected from SI is used.

DL and UL transmissions are organized into frames with 10 ms duration, consisting of ten subframes, each comprising 1 ms. Each frame is divided into two equally-sized half-frames of five subframes each. The slot duration is 14 symbols with Normal CP and 12 symbols with Extended CP, and scales in time as a function of the used sub-carrier spacing so that there is always an integer number of slots in a subframe.

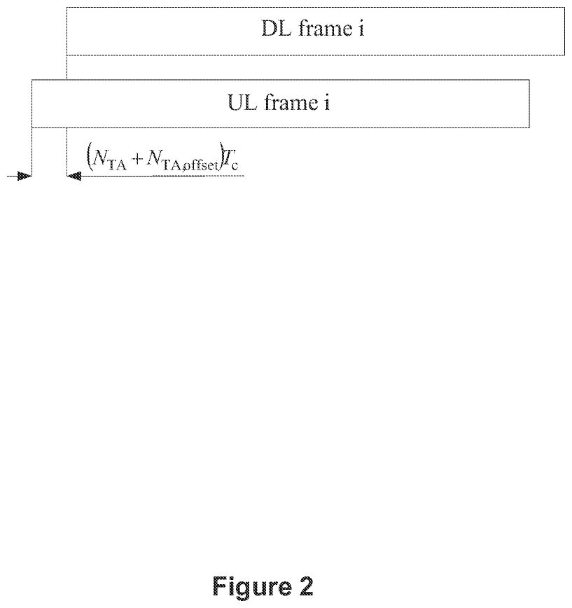

Please refer to FIG. 2, which illustrates an overview of UL-DL timing relation according to an example implementation of the present disclosure. As shown in FIG. 2, Timing Advance TA is used to adjust timing of the UL frame i relative to timing of the DL frame i. Operation on both paired and unpaired spectrum is supported.

DL

DL Transmission Scheme

A closed loop DMRS based spatial multiplexing is supported for PDSCH. Up to 8 and 12 orthogonal DL DMRS ports are supported for type 1 and type 2 DMRS, respectively. Up to 8 orthogonal DL DMRS ports per UE are supported for SU-MIMO and up to 4 orthogonal DL DMRS ports per UE are supported for MU-MIMO. The number of SU-MIMO code words is one for 1-4 layer transmissions and two for 5-8 layer transmissions.

The DMRS and corresponding PDSCH are transmitted using the same precoding matrix and the UE does not need to know the precoding matrix to demodulate the transmission. The transmitter may use different precoder matrix for different parts of the transmission bandwidth, resulting in frequency selective precoding. The UE may also assume that the same precoding matrix is used across a set of PRBs denoted PRG. Transmission durations from 2 to 14 symbols in a slot is supported. Aggregation of multiple slots with TB repetition is supported.

Physical-Layer Processing for PDSCH

The DL physical-layer processing of transport channels consists of the following steps:
TB CRC attachment;
Code block segmentation and code block CRC attachment;
Channel coding: LDPC coding;
Physical-layer HARQ processing;
Rate matching;
Scrambling;
Modulation: QPSK, 16QAM, 64QAM and 256QAM;
Layer mapping;
Mapping to assigned resources and antenna ports.

The UE may assume that at least one symbol with demodulation RS is present on each layer in which PDSCH is transmitted to a UE, and up to 3 additional DMRS can be configured by higher layers. Phase Tracking RS may be transmitted on additional symbols to aid receiver phase tracking. The DL-SCH physical layer model is described in TS 38.202.

PDCCHs

The PDCCH may be used to schedule DL transmissions on PDSCH and UL transmissions on PUSCH, where the DCI on PDCCH includes:
DL assignments containing at least modulation and coding format, resource allocation, and HARQ information related to DL-SCH;
UL scheduling grants containing at least modulation and coding format, resource allocation, and HARQ information related to UL-SCH.

In addition to scheduling, PDCCH may be used to for:
Activation and deactivation of configured PUSCH transmission with configured grant;
Activation and deactivation of PDSCH SP transmission;
Notifying one or more UEs of the slot format;
Notifying one or more UEs of the PRB(s) and OFDM symbol(s) where the UE may assume no transmission is intended for the UE;
Transmission of TPC commands for PUCCH and PUSCH;
Transmission of one or more TPC commands for SRS transmissions by one or more UEs;
Switching a UE's active BWP;
Initiating a RA procedure;
Indicating the UE(s) to monitor the PDCCH during the next occurrence of the DRX on-duration.

A UE monitors a set of PDCCH candidates in the configured monitoring occasions in one or more configured CORESETs according to the corresponding search space configurations.

A CORESET consists of a set of PRBs with a time duration of 1 to 3 OFDM symbols. The resource units REGs and CCEs are defined within a CORESET with each CCE consisting of a set of REGs. Control channels are formed by aggregation of the CCE. Different code rates for the control channels are realized by aggregating different number of the CCE. Interleaved and non-interleaved CCE-to-REG mapping are supported in a CORESET. Polar coding is used for PDCCH. Each REG carrying PDCCH carries its own DMRS. QPSK modulation is used for PDCCH.

SS and PBCH Block

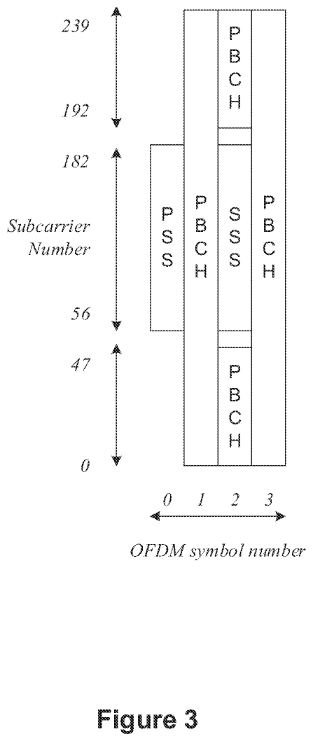

Please refer to FIG. 3, which illustrates an overview of time-frequency structure of SSB according to an example implementation of the present disclosure. As shown in FIG. 3, the SSB consists of PSS and SSS, each occupies 1 symbol and 127 subcarriers and PBCH spans across 3 OFDM symbols and 240 subcarriers, but on one symbol leaves an unused part in the middle for SSS. The possible time locations of SSBs within a half-frame are determined by sub-carrier spacing and the periodicity of the half-frames, where SSBs are transmitted is configured by the NW. During a half-frame, different SSBs may be transmitted in different spatial directions (i.e. using different beams, spanning the coverage area of a cell).

Within the frequency span of a carrier, multiple SSBs can be transmitted. The PCIs of SSBs transmitted in different frequency locations do not have to be unique, i.e. different SSBs in the frequency domain may have different PCIs. However, when an SSB is associated with an RMSI, the SSB corresponds to an individual cell, which has a unique NCGI. Such an SSB is referred to as a Cell-Defining SSB (CD-SSB). A PCell is always associated to a CD-SSB located on the synchronization raster. Polar coding is used for PBCH. The UE may assume a band-specific sub-carrier spacing for the SSB unless a NW has configured the UE to assume a different sub-carrier spacing. PBCH symbols carry its own frequency-multiplexed DMRS. QPSK modulation is used for PBCH. The PBCH physical layer model may be described in TS 38.202.

Physical Layer Procedures

Link Adaptation

Link adaptation (AMC: adaptive modulation and coding) with various modulation schemes and channel coding rates is applied to the PDSCH. The same coding and modulation is applied to all groups of resource blocks belonging to the same L2 PDU scheduled to one user within one transmission duration and within a MIMO codeword.

For channel state estimation purposes, the UE may be configured to measure CSI-RS and estimate the DL channel state based on the CSI-RS measurements. The UE feeds the estimated channel state back to the gNB to be used in link adaptation.

Power Control

DL power control can be used.

Cell Search

Cell search is the procedure by which a UE acquires time and frequency synchronization with a cell and detects the Cell ID of that cell. NR cell search is based on the PSS, SSS, and PBCH DMRS, located on the synchronization raster.

HARQ

Asynchronous Incremental Redundancy HARQ is supported. The gNB provides the UE with the HARQ-ACK feedback timing either dynamically in the DCI or semi-statically in an RRC configuration. Retransmission of HARQ-ACK feedback is supported for operation with shared spectrum channel access by using enhanced dynamic codebook and/or one-shot triggering of HARQ-ACK transmission for all configured CCs and HARQ processes in the PUCCH group.

The UE may be configured to receive code block group based transmissions, where retransmissions may be scheduled to carry a sub-set of all the code blocks of a TB.

Reception of SIB1

The MIB on PBCH provides the UE with parameters (e.g. CORESET #0 configuration) for monitoring of PDCCH for scheduling PDSCH that carries the SIB1. PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

DL RSs and Measurements for Positioning

The DL Positioning RSs (DL PRSs) are defined to facilitate support of different positioning methods such as DL Time Difference of Arrival (TDOA), DL Angle of departure (AoD), multi Round Trip Time (RTT) through the following set of UE measurements DL Reference Signal Time Difference (RSTD), DL PRS-RSRP, and UE Rx-Tx time difference respectively, as described in TS 38.305.

Besides DL PRS signals, UE may use SSB and CSI-RS for RRM (e.g., RSRP and RSRQ) measurements for Enhanced Cell D (E-CID) type of positioning.

UL

UL Transmission Scheme

Two transmission schemes are supported for PUSCH: codebook based transmission and non-codebook based transmission.

For codebook based transmission, the gNB provides the UE with a transmit precoding matrix indication in the DCI. The UE uses the indication to select the PUSCH transmit precoder from the codebook. For non-codebook based transmission, the UE determines its PUSCH precoder based on a wideband SRI field from the DCI.

A closed loop DMRS based spatial multiplexing is supported for PUSCH. For a given UE, up to 4 layer transmissions are supported. The number of code words is one. When transform precoding is used, only a single MIMO layer transmission is supported. Transmission durations from 1 to 14 symbols in a slot is supported. Aggregation of multiple slots with TB repetition is supported.

Two types of frequency hopping are supported, intra-slot frequency hopping, and in case of slot aggregation, inter-slot frequency hopping. Intra-slot and inter-slot frequency hopping are not supported when PRB interlace uplink transmission waveform is used.

PUSCH may be scheduled with the DCI on PDCCH, or a semi-static configured grant may be provided over the RRC, where two types of operation are supported:
The first PUSCH is triggered with a DCI, with subsequent PUSCH transmissions following the RRC configuration and scheduling received on the DCI; and
The PUSCH is triggered by data arrival to the UE's transmit buffer and the PUSCH transmissions follow the RRC configuration.

Physical-Layer Processing for PUSCH

The UL physical-layer processing of transport channels consists of the following steps:
TB CRC attachment;
Code block segmentation and Code Block CRC attachment;
Channel coding: LDPC coding;
Physical-layer HARQ processing;
Rate matching;
Scrambling;
Modulation: π/2 BPSK (with transform precoding only), QPSK, 16QAM, 64QAM and 256QAM;
Layer mapping, transform precoding (enabled/disabled by configuration), and pre-coding;
Mapping to assigned resources and antenna ports.

The UE transmits at least one symbol with demodulation reference signal on each layer on each frequency hop in which the PUSCH is transmitted, and up to 3 additional DMRS may be configured by higher layers. Phase Tracking RS may be transmitted on additional symbols to aid receiver phase tracking. The UL-SCH physical layer model is described in TS 38.202. For configured grants operation with shared spectrum channel access, a Configured Grant Uplink Control Information (CG-UCI) is transmitted in PUSCH scheduled by configured UL grant.

PUCCH

The PUCCH carries the UCI from the UE to the gNB. Five formats of PUCCH exist, depending on the duration of PUCCH and the UCI payload size in the following:
Format #0: Short PUCCH of 1 or 2 symbols with small UCI payloads of up to two bits with UE multiplexing capacity of up to 6 UEs with 1-bit payload in the same PRB;
Format #1: Long PUCCH of 4-14 symbols with small UCI payloads of up to two bits with UE multiplexing capacity of up to 84 UEs without frequency hopping and 36 UEs with frequency hopping in the same PRB;
Format #2: Short PUCCH of 1 or 2 symbols with large UCI payloads of more than two bits with no UE multiplexing capability in the same PRBs;
Format #3: Long PUCCH of 4-14 symbols with large UCI payloads with no UE multiplexing capability in the same PRBs;
Format #4: Long PUCCH of 4-14 symbols with moderate UCI payloads with multiplexing capacity of up to 4 UEs in the same PRBs.

The short PUCCH format of up to two UCI bits is based on sequence selection, while the short PUCCH format of more than two UCI bits frequency multiplexes UCI and DMRS. The long PUCCH formats time-multiplex the UCI and DMRS. Frequency hopping is supported for long PUCCH formats and for short PUCCH formats of duration of 2 symbols. Long PUCCH formats can be repeated over multiple slots.

For operation with shared spectrum channel access, PUCCH Format #0, #1, #2, #3 are extended to use resource in one PRB interlace (up to two interlaces for Format #2 and Format #3) in one RB Set. PUCCH Format #2 and #3 are enhanced to support multiplexing capacity of up to 4 UEs in the same PRB interlace when one interlace is used.

UCI multiplexing in PUSCH is supported when UCI and PUSCH transmissions coincide in time, either due to transmission of a UL-SCH transport block or due to triggering of A-CSI transmission without UL-SCH transport block:
UCI carrying HARQ-ACK feedback with 1 or 2 bits is multiplexed by puncturing PUSCH;
In all other cases UCI is multiplexed by rate matching PUSCH.

The UCI consists of the following information:
CSI;
ACK/NAK;
Scheduling request.

For operation with shared spectrum channel access, multiplexing of CG-UCI and PUCCH carrying HARQ-ACK feedback can be configured by the gNB. If not configured, when PUCCH overlaps with PUSCH scheduled by a configured grant within a PUCCH group and PUCCH carries HARQ ACK feedback, PUSCH scheduled by configured grant is skipped.

QPSK and π/2 BPSK modulation can be used for long PUCCH with more than 2 bits of information, QPSK is used for short PUCCH with more than 2 bits of information and BPSK and QPSK modulation can be used for long PUCCH with up to 2 information bits.

Transform precoding is applied to PUCCH Format #3 and Format #4.

More details of channel coding used for UCI are described in Table 2.

TABLE 2

| Uplink Control Information size | |
|---|---|
| including CRC, if present | Channel code |
| 1 | Repetition code |
| 2 | Simplex code |
| 3-11 | Reed Muller code |
| >11 | Polar code |

RA

The RA preamble sequences of four different lengths are supported. Sequence length 839 is applied with subcarrier spacings of 1.25 and 5 kHz, sequence length 139 is applied with subcarrier spacings of 15, 30, 60 and 120 kHz, and sequence lengths of 571 and 1151 are applied with subcarrier spacings of 30 kHz and 15 kHz, respectively. Sequence length 839 supports unrestricted sets and restricted sets of Type A and Type B, while sequence lengths 139, 571, and 1151 support unrestricted sets only. Sequence length 839 is only used for operation with licensed channel access while sequence length 139 can be used for operation with either licensed or shared spectrum channel access. Sequence lengths of 571 and 1151 can be used only for operation with shared spectrum channel access.

Multiple PRACH preamble formats are defined with one or more PRACH OFDM symbols, and different cyclic prefix and guard time. The PRACH preamble configuration to use is provided to the UE in the SI. The UE calculates the PRACH transmit power for the retransmission of the preamble based on the most recent estimate pathloss and power ramping counter. The SI provides information for the UE to determine the association between the SSB and the RACH resources. The RSRP threshold for SSB selection for RACH resource association is configurable by NW.

Physical Layer Procedures

Link Adaptation

Four types of link adaptation are supported as follows:
Adaptive transmission bandwidth;
Adaptive transmission duration;
Transmission power control;
Adaptive modulation and channel coding rate.

For channel state estimation purposes, the UE may be configured to transmit SRS that the gNB may use to estimate the UL channel state and use the estimate in link adaptation.

UL Power Control

The gNB determines the desired UL transmit power and provides UL transmit power control commands to the UE. The UE uses the provided UL transmit power control commands to adjust its transmit power.

UL Timing Control

The gNB determines the desired TA setting and provides that to the UE. The UE uses the provided TA to determine its UL transmit timing relative to the UE's observed DL receive timing.

HARQ

Asynchronous Incremental Redundancy HARQ is supported. The gNB schedules each UL transmission and retransmission using the UL grant on DCI. For operation with shared spectrum channel access, the UE can also retransmit on configured grants.

The UE may be configured to transmit code block group based transmissions where retransmissions may be scheduled to carry a sub-set of all the code blocks of a TB.

Up to two HARQ-ACK codebooks corresponding to a priority (high/low) can be constructed simultaneously. For each HARQ-ACK codebook, more than one PUCCH for HARQ-ACK transmission within a slot is supported. Each PUCCH is limited within one sub-slot, and the sub-slot pattern is configured per HARQ-ACK codebook.

Prioritization of Overlapping Transmissions

PUSCH and PUCCH can be associated with a priority (high/low) by RRC or L1 signalling. If a PUCCH transmission overlaps in time with a transmission of a PUSCH or another PUCCH, only the PUCCH or PUSCH associated with a high priority can be transmitted.

UL RSs and Measurements for Positioning

The periodic, SP and AP transmission of Rel-15 SRS is defined for gNB UL Relative Time of Arrival (RTOA), UL SRS-RSRP, UL Angle of Arrival (AoA) measurements to facilitate support of UL TDOA and UL AoA positioning methods as described in TS 38.305.

The periodic, SP and AP transmission of SRS for positioning is defined for gNB UL RTOA, UL SRS-RSRP, UL-AoA, gNB Rx-Tx time difference measurements to facilitate support of UL TDOA, UL AoA and multi-RTT positioning methods as described in TS 38.305.

CA

In the CA, two or more CCs are aggregated. A UE may simultaneously receive or transmit on one or multiple CCs depending on its capabilities:
A UE with single TA capability for CA can simultaneously receive and/or transmit on multiple CCs corresponding to multiple serving cells sharing the same TA (multiple serving cells grouped in one TAG);
A UE with multiple TA capability for CA can simultaneously receive and/or transmit on multiple CCs corresponding to multiple serving cells with different TAs (multiple serving cells grouped in multiple TAGs). NG-RAN ensures that each TAG contains at least one serving cell;
A non-CA capable UE can receive on a single CC and transmit on a single CC corresponding to one serving cell only (one serving cell in one TAG).

CA is supported for both contiguous and non-contiguous CCs. When CA is deployed frame timing and SFN are aligned across cells that can be aggregated, or an offset in multiples of slots between the PCell/PSCell and an SCell is configured to the UE. The maximum number of configured CCs for a UE is 16 for DL and 16 for UL.

SUL

In conjunction with a UL/DL carrier pair (FDD band) or a bidirectional carrier (TDD band), a UE may be configured with additional SUL. The SUL differs from the aggregated UL in that the UE may be scheduled to transmit either on the SUL or on the UL of the carrier being supplemented, but not on both at the same time.

Activation/Deactivation of SP SRS

The NW may activate and deactivate the configured SP SRS resource sets of a Serving Cell by sending the SP SRS Activation/Deactivation MAC CE. The configured SP SRS resource sets are initially deactivated upon configuration and after a handover.

The MAC entity shall:

1> if the MAC entity receives an SP SRS Activation/Deactivation MAC CE on a Serving Cell:

2> indicate to lower layers the information regarding the SP SRS Activation/Deactivation MAC CE.

Indication of Spatial Relation of SP/AP SRS

The NW may indicate the spatial relation info of SP/AP SRS resource sets of a Serving Cell by sending the Enhanced SP/AP SRS spatial relation Indication MAC CE.

The MAC entity shall:

1> if the MAC entity receives an Enhanced SP/AP SRS spatial relation Indication MAC CE on a Serving Cell:

2> indicate to lower layers the information regarding the Enhanced SP/AP SRS spatial relation Indication MAC CE.

Activation/Deactivation of SP Positioning SRS

The NW may activate and deactivate the configured resource sets of SP Positioning SRS of a Serving Cell by sending the SP Positioning SRS Activation/Deactivation MAC CE. The configured resource sets SP Positioning SRS are initially deactivated upon configuration and after a handover.

The MAC entity shall:

1> if the MAC entity receives an SP Positioning SRS Activation/Deactivation MAC CE on a Serving Cell:

2> indicate to lower layers the information regarding the SP Positioning SRS Activation/Deactivation MAC CE.

SP SRS Activation/Deactivation MAC CE

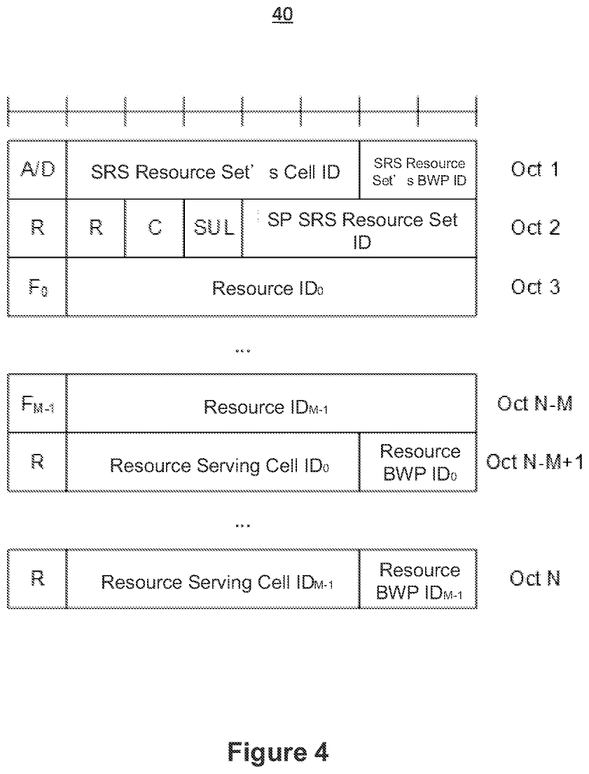

Please refer to FIG. 4, which illustrates an overview of a SP SRS Activation/Deactivation MAC CE 40 according to an example implementation of the present disclosure. As shown in FIG. 4, the SP SRS Activation/Deactivation MAC CE 40 is identified by a MAC subheader with LCID. It has a variable size with following fields:
A/D: This field indicates whether to activate or deactivate an indicated SP SRS resource set. The field is set to 1 to indicate activation, otherwise it indicates deactivation;
SRS Resource Set's Cell ID: This field indicates the identity of the Serving Cell, which contains an activated/deactivated SP SRS Resource Set. If the C field is set to 0, this field also indicates the identity of the Serving Cell which contains all resources indicated by the Resource IDᵢ fields. The length of the field is 5 bits;
SRS Resource Set's BWP ID: This field indicates a UL BWP as the codepoint of the DCI BWP indicator field as specified in TS 38.212, which contains activated/deactivated SP SRS Resource Set. If the C field is set to 0, this field also indicates the identity of the BWP which contains all resources indicated by the Resource IDᵢ fields. The length of the field is 2 bits;
C: This field indicates whether the octets (Oct) containing Resource Serving Cell ID field(s) and Resource BWP ID field(s) are present. If this field is set to 1, the octets containing Resource Serving Cell ID field(s) and Resource BWP ID field(s) are present, otherwise they are not present;
SUL: This field indicates whether the MAC CE applies to the NUL carrier or SUL carrier configuration. This field is set to 1 to indicate that it applies to the SUL carrier configuration, and it is set to 0 to indicate that it applies to the NUL carrier configuration;
SP SRS Resource Set ID: This field indicates the SP SRS Resource Set ID identified by SRS-ResourceSetId as specified in TS 38.331, which is to be activated or deactivated. The length of the field is 4 bits;
Fi: This field indicates the type of a resource used as a spatial relationship for SRS resource within SP SRS Resource Set indicated with SP SRS Resource Set ID field. F0 refers to the first SRS resource within the resource set, F1 to the second one and so on. The field is set to 1 to indicate NZP CSI-RS resource index is used, and it is set to 0 to indicate either SSB index or SRS resource index is used. The length of the field is 1 bit. This field is only present if the MAC CE is used for activation, i.e. the A/D field is set to 1;
Resource IDᵢ: This field contains an identifier of the resource used for spatial relationship derivation for SRS resource i. Resource ID0 refers to the first SRS resource within the resource set, Resource ID1 to the second one and so on. If Fi is set to 0, and the first bit of this field is set to 1, the remainder of this field contains SSB-Index as specified in TS 38.331. If Fi is set to 0, and the first bit of this field is set to 0, the remainder of this field contains SRS-ResourceId as specified in TS 38.331. The length of the field is 7 bits. This field is only present if the MAC CE is used for activation, i.e. the A/D field is set to 1;
Resource Serving Cell IDᵢ: This field indicates the identity of the Serving Cell on which the resource used for spatial relationship derivation for SRS resource i is located. The length of the field is 5 bits;
Resource BWP IDᵢ: This field indicates a UL BWP as the codepoint of the DCI BWP indicator field as specified in TS 38.212, on which the resource used for spatial relationship derivation for SRS resource i is located. The length of the field is 2 bits;
R: Reserved bit, set to 0.

Enhanced SP/AP SRS Spatial Relation Indication MAC CE

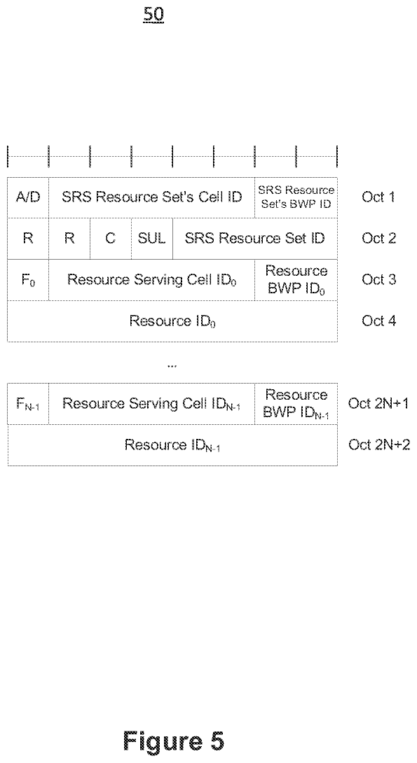

Please refer to FIG. 5, which illustrates an Enhanced SP/AP spatial relation Indication MAC CE 50 According to an example implementation of the present disclosure. As shown in FIG. 5, the Enhanced SP/AP SRS Spatial Relation Indication MAC CE 50 is identified by a MAC subheader with eLCID. It has a variable size with following fields:
A/D: This field indicates whether to activate or deactivate indicated SP SRS resource set. The field is set to 1 to indicate activation, otherwise it indicates deactivation. If the indicated SRS resource set ID is for the AP SRS resource set, the MAC entity shall ignore this field;
SRS Resource Set's Cell ID: This field indicates the identity of the Serving Cell, which contains the indicated SP/AP SRS Resource Set. If the C field is set to 0, this field also indicates the identity of the Serving Cell which contains all resources indicated by the Resource IDᵢ fields. The length of the field is 5 bits;
SRS Resource Set's BWP ID: This field indicates a UL BWP as the codepoint of the DCI BWP indicator field as specified in TS 38.212, which contains the indicated SP/AP SRS Resource Set. If the C field is set to 0, this field also indicates the identity of the BWP which contains all resources indicated by the Resource IDᵢ fields. The length of the field is 2 bits;
C: This field indicates whether the octets containing Resource Serving Cell ID field(s) and Resource BWP ID field(s) are present. If this field is set to 1, Resource Serving Cell ID field(s) and Resource BWP ID field(s) are present, otherwise they are not present so MAC entity shall ignore Resource Serving Cell ID field(s) and Resource BWP ID field(s);
SUL: This field indicates whether the MAC CE applies to the NUL carrier or SUL carrier configuration. This field is set to 1 to indicate that it applies to the SUL carrier configuration, and it is set to 0 to indicate that it applies to the NUL carrier configuration;
SRS Resource Set ID: This field indicates the SP/AP SRS Resource Set ID identified by SRS-ResourceSetId as specified in TS 38.331. The length of the field is 4 bits;
Fi: This field indicates the type of a resource used as a spatial relationship for SRS resource within SP/AP SRS Resource Set indicated with SP/AP SRS Resource Set ID field. F0 refers to the first SRS resource within the resource set, F1 to the second one and so on. The field is set to 1 to indicate NZP CSI-RS resource index is used, and it is set to 0 to indicate either SSB index or SRS resource index is used. The length of the field is 1 bit;
Resource Serving Cell IDᵢ: This field indicates the identity of the Serving Cell on which the resource used for spatial relationship derivation for SRS resource i is located. The length of the field is 5 bits;
Resource BWP IDᵢ: This field indicates a UL BWP as the codepoint of the DCI BWP indicator field as specified in TS 38.212, on which the resource used for spatial relationship derivation for SRS resource i is located. The length of the field is 2 bits;
Resource IDᵢ: This field contains an identifier of the resource used for spatial relationship derivation for SRS resource i. Resource ID0 refers to the first SRS resource within the resource set, Resource ID1 to the second one and so on. If Fi is set to 0, the first bit of this field is always set to 0. If Fi is set to 0, and the second bit of this field is set to 1, the remainder of this field contains SSB-Index as specified in TS 38.331. If Fi is set to 0, and the second bit of this field is set to 0, the remainder of this field contains SRS-ResourceId as specified in TS 38.331. The length of the field is 8 bits.
R: Reserved bit, set to 0.

SP Positioning SRS Activation/Deactivation MAC CE

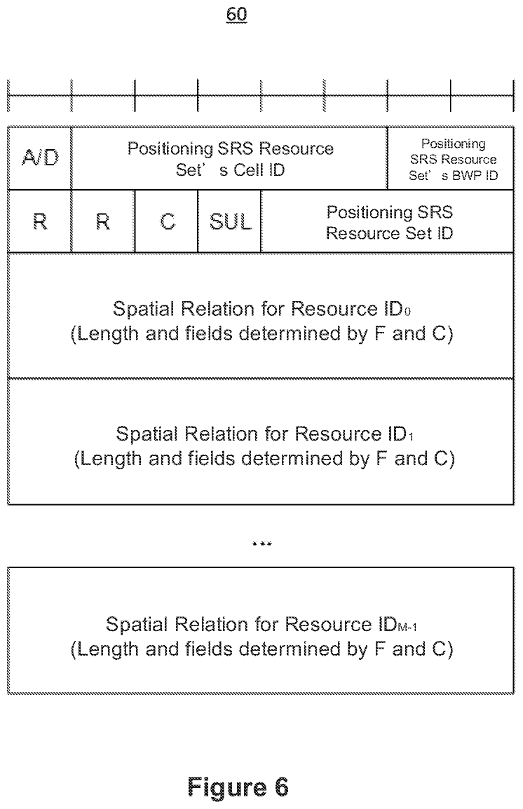

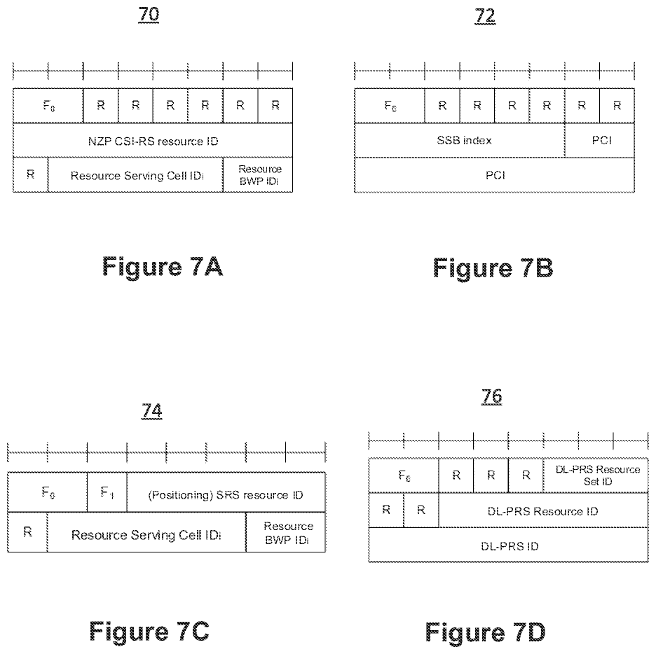

Please refer to FIG. 6, which illustrates a SP Positioning SRS Activation/Deactivation MAC CE 60 according to an example implementation of the present disclosure. As shown in FIG. 6, the SP Positioning SRS Activation/Deactivation MAC CE is identified by a MAC subheader with LCID and eLCID. It has a variable size with following fields:
A/D: This field indicates whether to activate or deactivate indicated SP Positioning SRS resource set. The field is set to 1 to indicate activation, otherwise it indicates deactivation;
Positioning SRS Resource Set's Cell ID: This field indicates the identity of the Serving Cell, which contains activated/deactivated SP Positioning SRS Resource Set. If the C field is set to 0, this field also indicates the identity of the Serving Cell which contains all resources indicated by the Spatial Relation for Resource IDᵢ fields if present. The length of the field is 5 bits;
Positioning SRS Resource Set's BWP ID: This field indicates a UL BWP as the codepoint of the DCI BWP indicator field as specified in TS 38.212, which contains activated/deactivated SP Positioning SRS Resource Set. If the C field is set to 0, this field also indicates the identity of the BWP which contains all resources indicated by the Spatial Relation for Resource IDᵢ fields if present. The length of the field is 2 bits;
C: This field indicates whether the octets containing Resource Serving Cell ID field(s) and Resource BWP ID field(s) within the field Spatial Relation for Resource IDᵢ are present, except for Spatial Relation Resource IDᵢ with DL-PRS or SSB. When A/D is set to 1, if this field is set to 1, the octets containing Resource Serving Cell ID field(s) and Resource BWP ID field(s) in the field Spatial Relation for Resource IDᵢ are present, otherwise they are not present. When A/D is set to 0, this field is always set to 0 that they are not present;
SUL: This field indicates whether the MAC CE applies to the NUL carrier or SUL carrier configuration. This field is set to 1 to indicate that it applies to the SUL carrier configuration, and it is set to 0 to indicate that it applies to the NUL carrier configuration;
Positioning SRS Resource Set ID: This field indicates the SP Positioning SRS Resource Set identified by SRS-PosResourceSetId as specified in TS 38.331, which is to be activated or deactivated. The length of the field is 4 bits;
Spatial Relation for Resource IDᵢ: The field Spatial Relation for Resource IDᵢ, is only present if MAC CE is used for activation, i.e. the A/D field is set to 1. M is the total number of Positioning SRS resource(s) configured under the SP Positioning SRS resource set indicated by the field Positioning SRS Resource Set ID. Please refer to FIGS. 7A to 7D, which illustrate different Spatial Relations for Resource IDᵢ according to example implementations of the present disclosure. As shown in FIGS. 7A to 7D, there are 4 types of Spatial Relation for Resource ID, which is indicated by the F (F0 and F1) field within. In details, FIG. 7A illustrates the Spatial Relation 70 for Resource IDᵢ with NZP CSI-RS, FIG. 7B illustrates the Spatial Relation 72 for Resource IDᵢ with SSB, FIG. 7C illustrates the Spatial Relation 74 for Resource IDᵢ with SRS, and FIG. 7D illustrates the Spatial Relation 76 for Resource IDᵢ with DL-PRS;
R: Reserved bit, set to 0.

Specifically, the field Spatial Relation for Resource IDᵢ consists of the following fields:
F0: This field indicates the type of a resource used as a spatial relation for the i^{th} Positioning SRS resource within the Positioning SRS Resource Set indicated with the field Positioning SRS Resource Set ID. The field is set to 00 to indicate NZP CSI-RS resource index is used; it is set to 01 to indicate SSB index is used; it is set to 10 to indicate SRS resource index is used; it is set to 11 to indicate DL-PRS index is used. The length of the field is 2 bits;
F1: This field indicates the type of SRS resource used as spatial relation for the i^{th} Positioning SRS resource within the SP Positioning SRS Resource Set indicated with the field Positioning SRS Resource Set ID when F0 is set to 10. The field is set to 0 to indicate SRS resource index SRS-ResourceId as defined in TS 38.331 is used; the field is set to 1 to indicate Positioning SRS resource index SRS-PosResourceId as defined in TS 38.331 is used;
NZP CSI-RS Resource ID: This field contains an index of NZP-CSI-RS-ResourceID, as specified in TS 38.331, indicating the NZP CSI-RS resource, which is used to derive the spatial relation for the positioning SRS. The length of the field is 8 bits;
SSB index: This field contains an index of SSB SSB-Index as specified in TS 38.331 and/or TS 37.355. The length of the field is 6 bits;
PCI: This field contains physical cell identity PhysCellId as specified in TS 38.331 and/or TS 37.355. The length of the field is 10 bits;
SRS resource ID: When F1 is set to 0, the field indicates an index for SRS resource SRS-ResourceId as defined in TS 38.331; When F1 is set to 1, the field indicates an index for Positioning SRS resource SRS-PosResourceId as defined in TS 38.331. The length of the field is 5 bits;
DL-PRS Resource Set ID: This field contains an index for DL-PRS Resource Set nr-DL-PRS-ResourceSetId as defined in TS 37.355. The length of the field is 3 bits;
DL-PRS Resource ID: This field contains an index for DL-PRS resource nr-DL-PRS-Resource ID as defined in TS 37.355. The length of the field is 6 bits;
DL-PRS ID: This field contains an identity for DL-PRS resource dl-PRS-ID as defined in TS 37.355. The length of the field is 8 bits;
Resource Serving Cell IDᵢ: This field indicates the identity of the Serving Cell on which the resource used for spatial relationship derivation for the i^{th} Positioning SRS resource is located. The length of the field is 5 bits;
Resource BWP IDᵢ: This field indicates a UL BWP as the codepoint of the DCI BWP indicator field as specified in TS 38.212, on which the resource used for spatial relationship derivation for the i^{th} Positioning SRS resource is located. The length of the field is 2 bits.

UE States and State Transitions Including Inter RAT

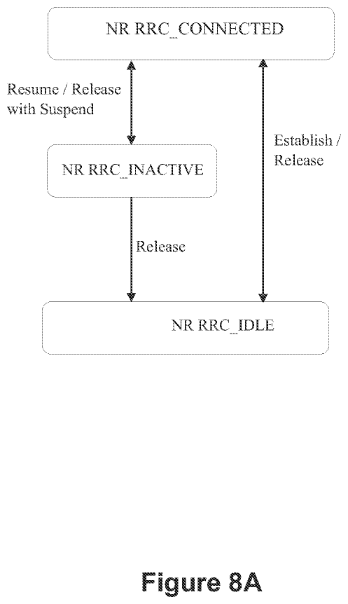

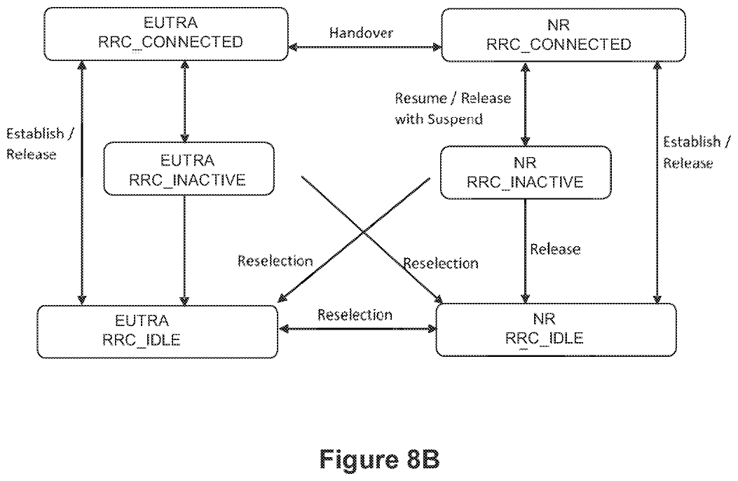

Please refer to FIGS. 8A and 8B, which illustrate different UE states and transitions according to example implementations of the present disclosure. Specifically, FIG. 8A illustrates UE states and transitions in NR, and FIG. 8B illustrates UE states and transitions between NR/SGC, E-UTRA/EPC and E-UTRA/SGC. As shown in FIGS. 8A and 8B, the UE is either in an RRC_CONNECTED state or in an RRC_INACTIVE state when an RRC connection has been established. If this is not the case, i.e. no RRC connection is established, the UE is in an RRC_IDLE state. The RRC states can further be characterized as follows:
RRC_IDLE:
   A UE specific DRX may be configured by upper layers;
   The UE controlled mobility based on NW configuration;
   The UE:
      Monitors Short Messages transmitted with P-RNTI over DCI;
      Monitors a Paging channel for CN paging using 5G-S-TMSI;
      Performs neighboring cell measurements and cell (re-)selection;
      Acquires SI and can send SI request (if configured).
      Performs logging of available measurements together with location and time for logged measurement configured UEs.
RRC_INACTIVE:
   A UE specific DRX may be configured by upper layers or by RRC layer;
   UE controlled mobility based on NW configuration;
   The UE stores the UE Inactive AS context;
   A RAN-based notification area is configured by RRC layer;
   The UE:
      Monitors Short Messages transmitted with P-RNTI over DCI;
      Monitors a Paging channel for CN paging using 5G-S-TMSI and RAN paging using fullI-RNTI;
      Performs neighboring cell measurements and cell (re-)selection;
      Performs RAN-based notification area updates periodically and when moving outside the configured RAN-based notification area;
      Acquires SI and can send SI request (if configured).
      Performs logging of available measurements together with location and time for logged measurement configured UEs.
RRC_CONNECTED:
   The UE stores the AS context;
   Transfer of unicast data to/from UE;
   At lower layers, the UE may be configured with a UE specific DRX;
   For UEs supporting CA, use of one or more SCells, aggregated with the SpCell, for increased bandwidth;
   For UEs supporting DC, use of one SCG, aggregated with the MCG, for increased bandwidth;
   NW controlled mobility within NR and to/from E-UTRA;
   The UE:
      Monitors Short Messages transmitted with P-RNTI over DCI, if configured;
      Monitors control channels associated with the shared data channel to determine if data is scheduled for it;
      Provides channel quality and feedback information;
      Performs neighboring cell measurements and measurement reporting;
      Acquires SI.

BWP-UplinkDedicated

The IE BWP-UplinkDedicated is used to configure the dedicated (UE specific) parameters of an uplink BWP. More details of BWP-UplinkDedicated IE are introduced in the following.

```
-- ASN1START
-- TAG-BWP-UPLINKDEDICATED-START
BWP-UplinkDedicated ::= SEQUENCE {
      pucch-Config SetupRelease { PUCCH-Config }
OPTIONAL, -- Need M
      pusch-Config SetupRelease { PUCCH-Config }
OPTIONAL, -- Need M
      configuredGrantConfig SetupRelease { ConfiguredGrantConfig }
OPTIONAL, -- Need M
      srs-Config SetupRelease { SRS-Config }
OPTIONAL, -- Need M
      beamFailureRecoveryConfig SetupRelease { BeamFailureRecoveryConfig }
OPTIONAL, -- Cond SpCellOnly
      ...,
      [ [
      sl-PUCCH-Config-r16 SetupRelease { PUCCH-Config }
OPTIONAL, -- Need M
      cp-ExtensionC2-r16 INTEGER (1..28)
OPTIONAL, -- Need R
      cp-ExtensionC3-r16 INTEGER (1..28)
OPTIONAL, -- Need R
      useInterlacePUCCH-PUSCH-r16 ENUMERATED {enabled}
OPTIONAL, -- Need R
      pucch-ConfigurationList-r16 SetupRelease { PUCCH-ConfigurationList-r16 }
OPTIONAL, -- Need M
      lbt-FailureRecoveryConfig-r16 SetupRelease { LBT-FailureRecoveryConfig-r16 }
OPTIONAL, -- Need M
      configuredGrantConfigToAddModList-r16 ConfiguredGrantConfigToAddModList-r16
OPTIONAL, -- Need N
      configuredGrantConfigToReleaseList-r16 ConfiguredGrantConfigToReleaseList-
r16 OPTIONAL, -- Need N
      configuredGrantConfigType2DeactivationStateList-r16
ConfiguredGrantConfigType2DeactivationStateList-r16 OPTIONAL -- Need R
      ] ]
}
ConfiguredGrantConfigToAddModList-r16 ::=SEQUENCE (SIZE (1..maxNrofConfiguredGrantConfig-
r16) ) OF ConfiguredGrantConfig
ConfiguredGrantConfigToReleaseList-r16 ::=SEQUENCE (SIZE (1..maxNrofConfiguredGrantConfig-
r16) ) OF ConfiguredGrantConfigIndex-r16
ConfiguredGrantConfigType2DeactivationState-r16 ::= SEQUENCE (SIZE
(1..maxNrofConfiguredGrantConfig-r16)) OF ConfiguredGrantConfigIndex-r16
ConfiguredGrantConfigType2DeactivationStateList-r16 ::=
                          SEQUENCE (SIZE (1..maxNrofCG-Type2DeactivationState) ) OF
ConfiguredGrantConfigType2DeactivationState-r16
-- TAG-BWP-UPLINKDEDICATED-STOP
-- ASN1STOP
```

SRS-CarrierSwitching

The IE SRS-CarrierSwitching is used to configure for SRS carrier switching when PUSCH is not configured and independent SRS power control from that of PUSCH. More details of SRS-CarrierSwitching IE are introduced in the following.

```
-- ASN1START
-- TAG-SRS-CARRIERSWITCHING-START
SRS-CarrierSwitching ::=  SEQUENCE {
    srs-SwitchFromServCellIndex INTEGER (0..31)
OPTIONAL, -- Need M
    srs-SwitchFromCarrier ENUMERATED {sUL, nUL},
    srs-TPC-PDCCH-Group CHOICE {
    typeA SEQUENCE (SIZE (1..32) ) OF SRS-TPC-PDCCH-Config,
    typeB SRS-TPC-PDCCH-Config
  }
OPTIONAL, -- Need M
    monitoringCells SEQUENCE (SIZE (1..maxNrofServingCells) ) OF
ServCellIndex OPTIONAL, -- Need M
    ...
}
SRS-TPC-PDCCH-Config ::= SEQUENCE {
    srs-CC-SetIndexlist SEQUENCE (SIZE(1..4) ) OF SRS-CC-SetIndex
OPTIONAL -- Need M
}
SRS-CC-SetIndex ::= SEQUENCE {
    cc-SetIndex INTEGER (0..3)
OPTIONAL, -- Need M
    cc-IndexInOneCC-Set INTEGER (0..7)
OPTIONAL -- Need M
}
-- TAG-SRS-CARRIERSWITCHING-STOP
-- ASN1STOP
```

More details are presented in the following:

1> SRS-CC-SetIndex field descriptions

cc-IndexInOneCC-Set
Indicates the CC index in one CC set for Type A (see TS 38.212, TS 38.213, clause 7.3.1, 11.4). The NW always
includes this field when the srs-TPC-PDCCH-Group is set to typeA. The NW does not configure this field to 3 in this
release of specification.
cc-SetIndex
Indicates the CC set index for Type A associated (see TS 38.212, TS 38.213, clause 7.3.1, 11.4). The NW always
includes this field when the srs-TPC-PDCCH-Group is set to typeA.

2> SRS-CarrierSwitching field descriptions

monitoringCells
A set of serving cells for monitoring PDCCH conveying SRS DCI format with CRC scrambled by TPC-SRS-RNTI (see
TS 38.212 [17], TS 38.213 [13], clause 7.3.1, 11.3).
srs-SwitchFromServCellIndex
Indicates the serving cell whose UL transmission may be interrupted during SRS transmission on a PUSCH-less SCell.
During SRS transmission on a PUSCH-less SCell, the UE may temporarily suspend the UL transmission on a serving
cell with PUSCH in the same CG to allow the PUSCH-less SCell to transmit SRS. (see TS 38.214, clause 6.2.1.3).
srs-TPC-PDCCH-Group
NW configures the UE with either typeA-SRS-TPC-PDCCH-Group or typeB-SRS-TPC-PDCCH-Group, if any.
typeA
Type A trigger configuration for SRS transmission on a PUSCH-less SCell (see TS 38.213, clause 11.4). In this release,
the NW configures at most one entry (the first entry) of typeA, and the first entry corresponds to the uplink carrier in
which the SRS-CarrierS witching field is configured.
typeB
Type B trigger configuration for SRS transmission on a PUSCH-less SCell (see TS 38.213, clause 11.4).

3> SRS-TPC-PDCCH-Config field descriptions

srs-CC-SetIndexlist
A list of pairs of [cc-SetIndex; cc-IndexInOneCC-Set] (see TS 38.212, TS 38.213, clause 7.3.1, 11.4). The NW does not
configure this field for typeB.

SRS-Config

The IE SRS-Config is used to configure SRS transmissions or to configure SRS measurements for CLI. The configuration defines a list of SRS-Resources and a list of SRS-ResourceSets. Each resource set defines a set of SRS-Resources. The NW triggers the transmission of the set of SRS-Resources using a configured aperiodicSRS-ResourceTrigger (L1 DCI). More details of SRS-Config IE are introduced in the following.

```
-- ASN1START
-- TAG-SRS-CONFIG-START
SRS-Config ::= SEQUENCE {
    srs-ResourceSetToReleaseList SEQUENCE (SIZE(1..maxNrofSRS-ResourceSets) ) OF SRS-
ResourceSetId OPTIONAL, -- Need N
    srs-ResourceSetToAddModList SEQUENCE (SIZE(1..maxNrofSRS-ResourceSets) ) OF SRS-
ResourceSetId OPTIONAL, -- Need N
    srs-ResourceToReleaseList SEQUENCE (SIZE(1..maxNrofSRS-Resources) ) OF SRS-
ResourceSetId OPTIONAL, -- Need N
    srs-ResourceToAddModList SEQUENCE (SIZE(1..maxNrofSRS-Resources) ) OF SRS-
ResourceSetId OPTIONAL, -- Need N
    tpc-Accumulation ENUMERATED {disabled}
OPTIONAL, -- Need S
    ...,
    [ [
    srs-RequestForDCI-Format1-2-r16 INTEGER (1..2)
OPTIONAL, -- Need S
    srs-RequestForDCI-Format0-2-r16 INTEGER (1..2)
OPTIONAL, -- Need S
    srs-ResourceSetToAddModListForDCI-Format0-2-r16 SEQUENCE (SIZE(1..maxNrofSRS-ResourceSets) )
OF SRS-ResourceSet OPTIONAL, -- Need N
    srs-ResourceSetToReleaseListForDCI-Format0-2-r16 SEQUENCE (SIZE(1..maxNrofSRS-
ResourceSets) ) OF SRS-ResourceSetId OPTIONAL, -- Need N
    srs-PosResourceSetToReleaseList-r16 SEQUENCE (SIZE(1..maxNrofSRS-PosResourceSets-r16) )
OF SRS-PosResourceSetId-r16
OPTIONAL, -- Need N
    srs-PosResourceSetToAddModList-r16 SEQUENCE (SIZE(1..maxNrofSRS-PosResourceSets-r16) )
OF SRS-PosResourceSet-r16 OPTIONAL, -- Need N
    srs-PosResourceToRe1easeList-r16 SEQUENCE (SIZE(1..maxNrofSRS-PosResources-r16) ) OF
SRS-PosResourceId-r16 OPTIONAL, -- Need N
    srs-PosResourceToAddModList-r16 SEQUENCE (SIZE(1..maxNrofSRS-PosResources-r16) ) OF
SRS-PosResource-r16 OPTIONAL -- Need N
    ] ]
}
SRS-ResourceSet ::= SEQUENCE {
    srs-ResourceSetId SRS-ResourceSetId,
    srs-ResourceIdList SEQUENCE (SIZE(1..maxNrofSRS-ResourcesPerSet) ) OF
SRS-ResourceId OPTIONAL, -- Cond Setup
    resourceType CHOICE {
        aperiodic SEQUENCE {
          aperiodicSRS-ResourceTrigger INTEGER (1..maxNrofSRS-TriggerStates-1),
          csi-RS NZP-CSI-RS-ResourceId
OPTIONAL, -- Cond NonCodebook
          slotOffset INTEGER (1..32)
OPTIONAL, -- Need S
          ...,
          [ [
          aperiodicSRS-ResourceTriggerList SEQUENCE (SIZE(1..maxNrofSRS-
TriggerStates-2))
                                                              OF INTEGER (1..maxNrofSRS-
TriggerStates-1) OPTIONAL -- Need M
          ] ]
      },
      semi-persistent SEQUENCE {
          associatedCSI-RS NZP-CSI-RS-ResourceId
OPTIONAL, -- Cond NonCodebook
              ...
        },
      periodic SEQUENCE {
          associatedCSI-RS NZP-CSI-RS-ResourceId
OPTIONAL, -- Cond NonCodebook
              ...
        }
    },
    usage ENUMERATED {beamManagement, codebook, nonCodebook,
antennaSwitching},
    alpha Alpha
OPTIONAL, -- Need S
    p0 INTEGER (−202..24)
OPTIONAL, -- Cond Setup
    pathlossReferenceRS PathlossReferenceRS-Config
OPTIONAL, -- Need M
    srs-PowerControlAdjustmentStates ENUMERATED { sameAsFci2, separateClosedLoop}
OPTIONAL, -- Need S
    ...,
    [ [
    pathlossReferenceRSList-r16 SetupRelease { PathlossReferenceRSList-r16}
OPTIONAL -- Need M
    ] ]
    }
PathlossReferenceRS-Config ::= CHOICE {
    ssb-Index SSB-Index,
    csi-RS-Index NZP-CSI-RS-ResourceId
}
PathlossReferenceRSList-r16 ::= SEQUENCE (SIZE (1..maxNrofSRS-PathlossReferenceRS-
r16) ) OF PathlossReferenceRS-r16
PathlossReferenceRS-r16 ::= SEQUENCE {
    srs-PathlossReferenceRS-Id-r16 SRS-PathlossReferenceRS-Id-r16,
    pathlossReferenceRS-r16 PathlossReferenceRS-Config
}
SRS-PathlossReferenceRS-Id-r16 ::= INTEGER (0..maxNrofSRS-PathlossReferenceRS-1-r16)
SRS-PosResourceSet-r16 ::= SEQUENCE {
    srs-PosResourceSetId-r16 SRS-PosResourceSetId-r16,
    srs-PosResourceIdList-r16 SEQUENCE (SIZE(1..maxNrofSRS-ResourcesPerSet) )
OF SRS-PosResourceId-r16
OPTIONAL, -- Cond Setup
    resourceType-r16 CHOICE {
        aperiodic-r16 SEQUENCE {
          aperiodicSRS-ResourceTriggerList-r16 SEQUENCE (SIZE(1..maxNrofSRS-
TriggerStates-1) )
                                                            OF INTEGER (1..maxNrofSRS-
TriggerStates-1) OPTIONAL, -- Need M
            ...
        },
        semi-persistent-r16 SEQUENCE {
            ...
        },
        periodic-r16 SEQUENCE {
            ...
        }
    },
    alpha-r16 Alpha
OPTIONAL, -- Need S
    p0-r16 INTEGER (−202..24)
OPTIONAL, -- Cond Setup
    pathlossReferenceRS-Pos-r16 CHOICE {
        ssb-IndexServing-r16 SSB-Index,
        ssb-Ncell-r16 SSB-InfoNcell-r16,
        dl-PRS-r16 DL-PRS-Info-r16
    }
OPTIONAL, -- Need M
    ...
}
SRS-ResourceSetId ::= INTEGER (0..maxNrofSRS-ResourceSets-1)
SRS-PosResourceSetId-r16 ::= INTEGER (0..maxNrofSRS-PosResourceSets-1-r16)
SRS-Resource ::= SEQUENCE {
    srs-ResourceId SRS-ResourceId,
    nrofSRS-Ports ENUMERATED {port1, ports2, ports4},
    ptrs-PortIndex ENUMERATED {n0, n1 }
OPTIONAL, -- Need R
    transmissionComb CHOICE {
        n2 SEQUENCE {
            combOffset-n2 INTEGER (0..1),
            cyclicShift-n2 INTEGER (0..7)
        },
        n4 SEQUENCE {
            combOffset-n4 INTEGER (0..3),
            cyclicShift-n4 INTEGER (0..11)
        }
    },
    resourceMapping SEQUENCE {
        startPosition INTEGER (0..5),
        nrofSymbols ENUMERATED {n1, n2, n4},
        repetitionFactor ENUMERATED {n1, n2, n4}
    },
    freqDomainPosition INTEGER (0..67),
    freqDomainShift INTEGER (0..268),
    freqHopping SEQUENCE {
        c-SRS INTEGER (0..63),
        b-SRS INTEGER (0..3),
        b-hop INTEGER (0..3)
    },
    groupOrSequenceHopping ENUMERATED { neither, groupHopping,
sequenceHopping },
    resourceType CHOICE {
        aperiodic SEQUENCE {
            ...
        },
        semi-persistent SEQUENCE {
            periodicityAndOffset-sp SRS-PeriodicityAndOffset,
            ...
        },
        periodic SEQUENCE {
            periodicityAndOffset-p SRS-PeriodicityAndOffset,
            ...
        }
    },
    sequenceId INTEGER (0..1023),
    spatialRelationInfo SRS-SpatialRelationInfo
OPTIONAL, -- Need R
    ...,
    [ [
    resourceMapping-r16 SEQUENCE {
        startPosition-r16 INTEGER (0..13),
        nrofSymbols-r16 ENUMERATED {n1, n2, n4},
        repetitionFactor-r16 ENUMERATED {n1, n2, n4}
    }
OPTIONAL -- Need R
    ] ]
}
SRS-PosResource-r16::= SEQUENCE {
    srs-PosResourceId-r16 SRS-PosResourceId-r16,
    transmissionComb-r16 CHOICE {
        n2-r16 SEQUENCE {
            combOffset-n2-r16 INTEGER (0..1),
            cyclicShift-n2-r16 INTEGER (0..7)
        },
        n4-r16 SEQUENCE {
            combOffset-n4-16 INTEGER (0..3),
            cyclicShift-n4-r16 INTEGER (0..11)
        },
        n8-r16 SEQUENCE {
            combOffset-n8-r16 INTEGER (0..7),
            cyclicShift-n8-r16 INTEGER (0..5)
        },
    ...
    },
    resourceMapping-r16 SEQUENCE {
        startPosition-r16 INTEGER (0..13),
        nrofSymbols-r16 ENUMERATED {n1, n2, n4, n8, n12}
    },
    freqDomainShift-r16 INTEGER (0..268),
    freqHopping-r16 SEQUENCE {
        c-SRS-r16 INTEGER (0..63)
        ...
    },
    groupOrSequenceHopping-r16 ENUMERATED { neither, groupHopping,
sequenceHopping },
    resourceType-r16 CHOICE {
        aperiodic-r16 SEQUENCE {
            slotOffset-r16 INTEGER (1..32)
OPTIONAL, -- Need S
            ...
        },
        semi-persistent-r16 SEQUENCE {
            periodicityAndOffset-sp-r16 SRS-PeriodicityAndOffset-r16,
            ...
        },
        periodic-r16 SEQUENCE {
            periodicityAndOffset-p-r16 SRS-PeriodicityAndOffset-r16,
            ...
        }
    },
    sequenceId-r16 INTEGER (0..65535),
    spatialRelationInfoPos-r16 SRS-SpatialRelationInfoPos-r16
OPTIONAL, -- Need R
    ...
    }
    SRS-SpatialRelationInfo ::= SEQUENCE {
    servingCellId ServCellIndex
OPTIONAL, -- Need S
    referenceSignal CHOICE {
        ssb-Index SSB-Index,
        csi-RS-Index NZP-CSI-RS-ResourceId,
        srs SEQUENCE {
              resourceId SRS-ResourceId,
              uplink BWP BWP-Id
        }
    }
}
SRS-SpatialRelationInfoPos-r16 ::= CHOICE {
    servingRS-r16 SEQUENCE {
        servingCellId ServCell Index OPTIONAL,
-- Need S
        referenceSignal-r16 CHOICE {
            ssb-IndexServing-r16 SSB-Index,
            csi-RS-IndexServing-r16 NZP-CSI-RS-ResourceId,
            srs-SpatialRelation-r16 SEQUENCE {
                resourceSelection-r16 CHOICE {
                  srs-ResourceId-r16 SRS-ResourceId,
                  srs-PosResourceId-r16 SRS-PosResourceId-r16
            },
            uplinkBWP-r16 BWP-Id
          }
        }
    },
    ssb-Ncell-r16 SSB-InfoNcell-r16,
    dl-PRS-r16 DL-PRS-Info-r16
}
SSB-Configuration-r16 ::= SEQUENCE {
    ssb-Freq-r16 ARFCN-ValueNR,
    halfFrameIndex-r16 ENUMERATED {zero, one},
    ssbSubcarrierSpacing-r16 SubcarrierSpacing,
    ssb-Periodicity-r16 ENUMERATED { ms5, ms10, ms20, ms40, ms80, ms160,
spare2,spare1 } OPTIONAL, -- Need S
    sfn0-Offset-r16 SEQUENCE {
        sfn-Offset-r16 INTEGER (0..1023),
        integerSubframeOffset-r16 INTEGER (0..9)
OPTIONAL -- Need R
    }
OPTIONAL, -- Need R
    sfn-SSB-Offset-r16 INTEGER (0..15),
    ss-PBCH-BlockPower-r16 INTEGER (−60..50)
OPTIONAL -- Cond Pathloss
}
SSB-InfoNcell-r16 ::= SEQUENCE {
    physicalCellId-r16 PhysCellId,
    ssb-IndexNcell-r16 SSB-Index
OPTIONAL, -- Need S
    ssb-Configuration-r16 SSB-Configuration-r16
OPTIONAL -- Need S
}
DL-PRS-Info-r16 ::= SEQUENCE {
    dl-PRS-ID-r16 INTEGER (0..255),
    dl-PRS-ResourceSetId-r16 INTEGER (0..7),
    dl-PRS-ResourceId-r16 INTEGER (0..63)
OPTIONAL -- Need S
}
SRS-ResourceId ::= INTEGER (0..maxNrofSRS-Resources-1)
SRS-PosResourceId-r16 ::= INTEGER (0..maxNrofSRS-PosResources-1-r16)
SRS-PeriodicityAndOffset ::= CHOICE {
    s11 NULL,
    s12 INTEGER(0..1),
    s14 INTEGER(0..3),
    s15 INTEGER(0..4),
    s18 INTEGER(0..7),
    s110 INTEGER(0..9),
    s116 INTEGER(0..15),
    s120 INTEGER(0..19),
    s132 INTEGER(0..31),
    s140 INTEGER(0..39),
    s164 INTEGER(0..63),
    s180 INTEGER(0..79),
    s1160 INTEGER(0..159),
    s1320 INTEGER(0..319),
    s1640 INTEGER(0..639),
    s11280 INTEGER(0..1279),
    s12560 INTEGER(0..2559)
}
SRS-PeriodicityAndOffset-r16 ::= CHOICE {
    s11 NULL,
    s12 INTEGER(0..1),
    s14 INTEGER(0..3),
    s15 INTEGER(0..4),
    s18 INTEGER(0..7),
    s110 INTEGER(0..9),
    s116 INTEGER(0..15),
    s120 INTEGER(0..19),
    s132 INTEGER(0..31),
    s140 INTEGER(0..39),
    s164 INTEGER(0..63),
    s180 INTEGER(0..79),
    s1160 INTEGER(0..159),
    s1320 INTEGER(0..319),
    s1640 INTEGER(0..639),
    s11280 INTEGER(0..1279),
    s12560 INTEGER(0..2559),
    s15120 INTEGER(0..5119),
    s110240 INTEGER(0..10239),
    s140960 INTEGER(0..40959),
    s181920 INTEGER(0..81919),
    ...
}
-- TAG-SRS-CONFIG-STOP
-- ASN1STOP
```

More details are presented in the following:

4> SRS-Config field descriptions

tpc-Accumulation
If the field is absent, UE applies TPC commands via accumulation. If disabled, UE applies the TPC command without
accumulation (this applies to SRS when a separate closed loop is configured for SRS) (see TS 38.213, clause 7.3).

5> SRS-Resource field descriptions

cyclicShift-n2
Cyclic shift configuration (see TS 38.214, clause 6.2.1).
cyclicShift-n4
Cyclic shift configuration (see TS 38.214, clause 6.2.1).
freqHopping
Includes parameters capturing SRS frequency hopping (see TS 38.214, clause 6.2.1). For CLI SRS-RSRP
measurement, the NW always configures this field such that b-hop > b-SRS.
groupOrSequenceHopping
Parameter(s) for configuring group or sequence hopping (see TS 38.211, clause 6.4.1.4.2). For CLI SRS-RSRP
measurement, the NW always configures this parameter to 'neither'.
nrofSRS-Ports
Number of ports. For CLI SRS-RSRP measurement, the NW always configures this parameter to 'port1'.
periodicityAndOffset-p
Periodicity and slot offset for this SRS resource. All values are in “number of slots”. Value s/1 corresponds to a
periodicity of 1 slot, value s/2 corresponds to a periodicity of 2 slots, and so on. For each periodicity the corresponding
offset is given in number of slots. For periodicity s/1 the offset is 0 slots (see TS 38.214, clause 6.2.1). For CLI SRS-
RSRP measurement, s/1280 and s/2560 cannot be configured.
periodicityAndOffset-sp
Periodicity and slot offset for this SRS resource. All values are in “number of slots”. Value s/1 corresponds to a
periodicity of 1 slot, value s/2 corresponds to a periodicity of 2 slots, and so on. For each periodicity the corresponding
offset is given in number of slots. For periodicity s/1 the offset is 0 slots (see TS 38.214, clause 6.2.1).
ptrs-PortIndex
The PTRS port index for this SRS resource for non-codebook based UL MIMO. This is only applicable when the
corresponding PTRS-UplinkConfig is set to CP-OFDM. The ptrs-PortIndex configured here must be smaller than the
maxNrofPorts configured in the PTRS-UplinkConfig (see TS 38.214, clause 6.2.3.1). This parameter is not applicable to
CLI SRS-RSRP measurement.
resourceMapping
OFDM symbol location of the SRS resource within a slot including nrofSymbols (number of OFDM symbols),
startPosition (value 0 refers to the last symbol, value 1 refers to the second last symbol, and so on) and repetitionFactor
(see TS 38.214, clause 6.2.1 and TS 38.211, clause 6.4.1.4). The configured SRS resource does not exceed the slot
boundary. If resourceMapping-r16 is signalled, UE shall ignore the resourceMapping (without suffix). For CLI SRS-
RSRP measurement, the NW always configures nrofSymbols and repetition Factor to 'n1'.
resourceType
Periodicity and offset for SP and periodic SRS resource (see TS 38.214, clause 6.2.1). For CLI SRS-RSRP
measurement, only 'periodic' is applicable for resourceType.
sequenceId
Sequence ID used to initialize pseudo random group and sequence hopping (see TS 38.214, clause 6.2.1).
servingCellId
The serving Cell ID of the source SSB, CSI-RS, or SRS for the spatial relation of the target SRS resource. If this field is
absent the SSB, the CSI-RS, or the SRS is from the same serving cell where the SRS is configured.
spatialRelationInfo
Configuration of the spatial relation between a reference RS and the target SRS. Reference RS can be SSB/CSI-
RS/SRS (see TS 38.214, clause 6.2.1). This parameter is not applicable to CLI SRS-RSRP measurement.
spatialRelationInfoPos
Configuration of the spatial relation between a reference RS and the target SRS. Reference RS can be SSB/CSI-
RS/SRS/DL-PRS (see TS 38.214, clause 6.2.1).
srs-RequestForDCI-Format0-2
Indicate the number of bits for “SRS request”in DCI format 0_2. When the field is absent, then the value of 0 bit for
“SRS request” in DCI format 0_2 is applied. If the parameter srs-RequestForDCI-Format0-2 is configured to value 1, 1
bit is used to indicate one of the first two rows of Table 7.3.1.1.2-24 in TS 38.212 for triggered AP SRS resource set. If
the value 2 is configured, 2 bits are used to indicate one of the rows of Table 7.3.1.1.2-24 in TS 38.212. When UE is
configured with supplementaryUplink, an extra bit (the first bit of the SRS request field) is used for the non-SUL/SUL
indication.
srs-RequestForDCI-Format1-2
Indicate the number of bits for “SRS request” in DCI format 1_2. When the field is absent, then the value of 0 bit for
“SRS request” in DCI format 1_2 is applied. When the UE is configured with supplementaryUplink, an extra bit (the first
bit of the SRS request field) is used for the non-SUL/SUL indication (see TS 38.214, clause 6.1.1.2).
srs-ResourceSetToAddModListForDCI-Format0_2
List of SRS resource set to be added or modified for DCI format 0_2 (see TS 38.212, clause 7.3.1).
srs-ResourceSetToReleaseListForDCI-Format0_2
List of SRS resource set to be released for DCI format 0_2 (see TS 38.212, clause 7.3.1).
transmissionComb
Comb value (2 or 4 or 8) and comb offset (0..combValue-1) (see TS 38.214, clause 6.2.1).

6> SRS-ResourceSet field descriptions

alpha
alpha value for SRS power control (see TS 38.213, clause 7.3). When the field is absent the UE applies the value 1.
aperiodicSRS-ResourceTriggerList
An additional list of DCI “code points” upon which the UE shall transmit SRS according to this SRS resource set
configuration (see TS 38.214, clause 6.1.1.2). When the field is not included during a reconfiguration of SRS-
ResourceSet of resourceType set to AP, UE maintains this value based on the Need M; that is, this list is not
considered as an extension of aperiodicSRS-ResourceTrigger for purpose of applying the general rule for extended list
in clause 6.1.3.
aperiodicSRS-Resource Trigger
The DCI “code point” upon which the UE shall transmit SRS according to this SRS resource set configuration (see TS
38.214, clause 6.1.1.2).
associatedCSI-RS
ID of CSI-RS resource associated with this SRS resource set in non-codebook based operation (see TS 38.214, clause
6.1.1.2).
csi-RS
ID of CSI-RS resource associated with this SRS resource set. (see TS 38.214, clause 6.1.1.2).
csi-RS-IndexServingcell
Indicates CSI-RS index belonging to a serving cell
p0
P0 value for SRS power control. The value is in dBm. Only even values (step size 2) are allowed (see TS 38.213,
clause 7.3).
pathlossReferenceRS
A reference signal (e.g. a CSI-RS config or a SS block) to be used for SRS path loss estimation (see TS 38.213, clause
7.3).
pathlossReferenceRS-Pos
A reference signal (e.g. a SS block or a DL PRS config) to be used for SRS path loss estimation (see TS 38.213, clause
7.3).
pathlossReferenceRSList
Multiple candidate pathloss reference RS(s) for SRS power control, where one candidate RS can be mapped to SRS
Resource Set via MAC CE (in TS 38.321). The NW can only configure this field if pathlossReferenceRS is not
configured in the same SRS-ResourceSet.
resourceSelection
Indicates whether the configured SRS spatial relation resource is a SRS-Resource or SRS-PosResource.
resourceType
Time domain behavior of SRS resource configuration, see TS 38.214, clause 6.2.1. The NW configures SRS resources
in the same resource set with the same time domain behavior on periodic, AP and SP SRS.
slotOffset
An offset in number of slots between the triggering DCI and the actual transmission of this SRS-ResourceSet. If the field
is absent the UE applies no offset (value 0).
srs-PowerControlAdjustmentStates
Indicates whether hsrs,c(i) = fc(i,1) or hsrs,c(i) = fc(i,2) (if twoPUSCH-PC-AdjustmentStates are configured) or separate
close loop is configured for SRS. This parameter is applicable only for ULs on which UE also transmits PUSCH. If absent
or release, the UE applies the value sameAs-Fci1 (see TS 38.213, clause 7.3).
srs-ResourceIdList
The IDs of the SRS-Resources used in this SRS-ResourceSet. If this SRS-ResourceSet is configured with usage set to
codebook, the srs-ResourceIdList contains at most 2 entries. If this SRS-ResourceSet is configured with usage set to
nonCodebook, the srs-ResourceIdList contains at most 4 entries.
srs-ResourceSetId
The ID of this resource set. It is unique in the context of the BWP in which the parent SRS-Config is defined.
ssb-IndexSevingcell
Indicates SSB index belonging to a serving cell
ssb-NCell
This field indicates a SSB configuration from neighboring cell
usage
Indicates if the SRS resource set is used for beam management, codebook based or non-codebook based transmission
or antenna switching. See TS 38.214, clause 6.2.1. Reconfiguration between codebook based and non-codebook
based transmission is not supported.

7> SSB-InfoNCell field descriptions

physicalCellId
This field specifies the physical cell ID of the neighbour cell for which SSB configuration is provided.
ssb-IndexNcell
This field specifies the index of the SSB for a neighbour cell. See TS 38.213. If this field is absent, the UE determines
the ssb-IndexNcell of the physicalCellId based on its SSB measurement from the cell.
ssb-Configuration
This field specifies the full configuration of the SSB. If this field is absent, the UE obtains the configuration for the SSB
from nr-SSB-Config received as part of DL PRS assistance data in LPP, see TS 37.355, by looking up the
corresponding SSB configuration using the field physicalCellId.

8> DL-PRS-Info field descriptions

dl-PRS-ID
This field specifies the UE specific TRP ID for which PRS configuration is provided.
dl-PRS-ResourceSetId
This field specifies the PRS-ResourceSet ID of a PRS resourceSet.
DI-PRS-ResourceId
This field specifies the PRS-Resource ID of a PRS resource. If this field is absent, the UE determines the dl-PRS-
ResourceID based on its PRS measurement from the TRP and DL PRS Resource Set.

9> SSB-Configuration field descriptions

halfFrameIndex
10> Indicates whether SSB is in the first half or the second half of the frame. Value zero indicates the first half and
value 1 indicates the second half.
integerSubframeOffset
Indicates the subframe boundary offset of the cell in which SSB is transmited.
sfn0-Offset
Indiactes the time offset of the SFN0 slot 0 for the cell with respect to SFN0 slot 0 of serving cell.
sfn-Offset
Indicates the 4 LSBs of the SFN of the cell in which SSB is transmitted.
ssb-Freq
Indicates the frequency of the SSB.
ssb-PBCH-BlockPower
Average EPRE of the resources elements that carry secondary synchronization signals in dBm that the NW used for
SSB transmission, see TS 38.213, clause 7.
ssb-Periodicity
Indicates the periodicity of the SSB. If the field is absent, the UE applies the value m55. (see TS 38.213, clause 4.1)
ssbSubcarrierSpacing
Subcarrier spacing of SSB. Only the values 15 kHz or 30 kHz (FR1), and 120 kHz or 240 kHz (FR2) are applicable.

| 11> Conditional | 12> Explanation |
|---|---|
| Presence | |
| Setup | This field is mandatory present upon configuration of SRS- |
| | ResourceSet or SRS-Resource and optionally present, Need M, |
| | otherwise. |
| NonCodebook | This field is optionally present, Need M, in case of non-codebook |
| | based transmission, otherwise the field is absent. |
| Pathloss | The field is mandatory present if the IE SSB-InfoNcell is included in |
| | pathlossReferenceRS-Pos; otherwise it is optionally present, Need R |

SRS-RSRP-Range

The IE SRS-RSRP-Range specifies the value range used in SRS-RSRP measurements and thresholds. The integer value for SRS-RSRP measurements is based on TS 38.133. For thresholds, the actual value is (IE value −140) dBm, except for the IE value 98, in which case the actual value is infinity. More details of SRS-RSRP-Range IE are introduced in the following.

-- ASN1START
-- TAG-SRS-RSRP-RANGE-START
SRS-RSRP-Range-r16 ::= INTEGER(0..98)
-- TAG-SRS-RSRP-RANGE-STOP
-- ASN1STOP

DCI

The DCI transports DCI for one or more cells with one RNTI. The following coding steps can be identified:
IE multiplexing;
CRC attachment;
Channel coding;
Rate matching.

More details of DCI formats are defined in the following:

| DCI format | Usage |
|---|---|
| 0_0 | Scheduling of PUSCH in one cell |
| 0_1 | Scheduling of one or multiple PUSCH in one cell, or |
| | indicating downlink feedback information for configured |
| | grant PUSCH (CG-DFI) |
| 0_2 | Scheduling of PUSCH in one cell |
| 1_0 | Scheduling of PDSCH in one cell |
| 1_1 | Scheduling of PDSCH in one cell, and/or triggering one |
| | shot HARQ-ACK codebook feedback |
| 1_2 | Scheduling of PDSCH in one cell |
| 2_0 | Notifying a group of UEs of the slot format, available RB |
| | sets, COT duration and search space set group switching |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |
| 2_4 | Notifying a group of UEs of the PRB(s) and OFDM |
| | symbol(s) where UE cancels the corresponding UL |
| | transmission from the UE |
| 2_5 | Notifying the availability of soft resources as defined in TS |
| | 38.473 |
| 2_6 | Notifying the power saving information outside DRX Active |
| | Time for one or more UEs |
| 3_0 | Scheduling of NR sidelink in one cell |
| 3_1 | Scheduling of LTE sidelink in one cell |

The fields defined in the DCI formats below are mapped to the information bits a₀ to a_{A-1} as follows.

Each field is mapped in the order in which it appears in the description, including the zero-padding bit(s), if any, with the first field mapped to the lowest order information bit a₀ and each successive field mapped to higher order information bits. The most significant bit of each field is mapped to the lowest order information bit for that field, e.g., the most significant bit of the first field is mapped to a₀. If the number of information bits in a DCI format is less than 12 bits, zeros shall be appended to the DCI format until the payload size equals 12. The size of each DCI format is determined by the configuration of the corresponding active bandwidth part of the scheduled cell and shall be adjusted if necessary.

UE Sounding Procedure

The UE may be configured with one or more SRS resource sets as configured by the higher layer parameter SRS-ResourceSet. For each SRS resource set, a UE may be configured with SRS resources (higher layer parameter SRS-Resource), where the maximum value of K is indicated by UE capability, as introduced in TS 38.306, except when SRS is configured with the higher layer parameter associated with SRS at least for positioning in which case the maximum value of K is 16. The SRS resource set applicability is configured by the higher layer parameter usage in SRS-ResourceSet. When the higher layer parameter usage is set to ‘beamManagement’, only one SRS resource in each of multiple SRS sets may be transmitted at a given time instant, but the SRS resources in different SRS resource sets with the same time domain behavior in the same BWP may be transmitted simultaneously.

For AP SRS at least one state of the DCI field is used to select at least one out of the configured SRS resource set(s). The following SRS parameters are semi-statically configurable by higher layer parameter SRS-Resource.
srs-ResourceId determines SRS resource configuration identity.
Number of SRS ports as defined by the higher layer parameter nrofSRS-Ports and described in TS 38.211. If not configured, nrofSRS-Ports is 1.
Time domain behaviour of SRS resource configuration as indicated by the higher layer parameter resourceType, which may be periodic, SP, AP SRS transmission as defined in TS 38.211.
Slot level periodicity and slot level offset as defined by the higher layer parameters periodicityAndOffset-p or periodicityAndOffset-sp for an SRS resource of type periodic or SP. The UE is not expected to be configured with SRS resources in the same SRS resource set SRS-ResourceSet with different slot level periodicities. For an SRS-ResourceSet configured with higher layer parameter resourceType set to ‘AP’, a slot level offset is defined by the higher layer parameter slotOffset except when SRS is configured with the higher layer parameter associated with SRS at least for positioning in which case the slot level offset is defined by the higher layer parameter slotOffset for each SRS resource.
Number of OFDM symbols in the SRS resource, starting OFDM symbol of the SRS resource within a slot including repetition factor R as defined by the higher layer parameter resourceMapping and described in TS 38.211. If R is not configured, then R is equal to the number of OFDM symbols in the SRS resource.
SRS bandwidth, as defined by the higher layer parameter freqHopping and described in TS 38.211. If not configured, then=0.
Frequency hopping bandwidth, as defined by the higher layer parameter freqHopping and described in TS 38.211. If not configured, then=0.
Defining frequency domain position and configurable shift, as defined by the higher layer parameters freqDomainPosition and freqDomainShift, respectively, and described in TS 38.211. If freqDomainPosition is not configured, freqDomainPosition is zero.
Cyclic shift, as defined by the higher layer parameter cyclicShift-n2, cyclicShift-n4, or cyclicShift-n8 for transmission comb value 2, 4 and 8, respectively, and described in TS 38.211.
Transmission comb value as defined by the higher layer parameter transmissionComb described in TS 38.211.
Transmission comb offset as defined by the higher layer parameter combOffset-n2, combOffset-n4, or combOffset-n8 for transmission comb value 2, 4, or 8 respectively, and described in TS 38.211.
SRS sequence ID as defined by the higher layer parameter sequenceId.
The configuration of the spatial relation between a reference RS and the target SRS, where the higher layer parameter spatialRelationInfo, if configured, contains the ID of the reference RS. The reference RS may be an SS/PBCH block, CSI-RS configured on serving cell indicated by higher layer parameter servingCellId if present, same serving cell as the target SRS otherwise, or an SRS configured on UL BWP indicated by the higher layer parameter uplinkBWP, and serving cell indicated by the higher layer parameter servingCellId if present, same serving cell as the target SRS otherwise. When SRS is configured by the higher layer parameter associated with SRS at least for positioning the reference RS may also be a DL PRS configured on a serving cell, an SS/PBCH block or a DL PRS of a non-serving cell indicated by a higher layer parameter.

The UE may be configured by the higher layer parameter resourceMapping in SRS-Resource with an SRS resource occupying adjacent symbols within the last 6 symbols of the slot, where all antenna ports of the SRS resources are mapped to each symbol of the resource. When the SRS is configured with the higher layer parameter associated with SRS at least for positioning the higher layer parameter resourceMapping in SRS-Resource with an SRS resource occupying N_{S}∈{1,2,4,8,12} adjacent symbols anywhere within the slot.

If a UE is not configured with a higher layer parameter related to intra-UE prioritization, and PUSCH and SRS configured by SRS-Resource are transmitted in the same slot on a serving cell, the UE may only be configured to transmit SRS after the transmission of the PUSCH and the corresponding DMRS.

If a UE is configured with a higher layer parameter related to intra-UE prioritization, and a PUSCH transmission may overlap in time with an SRS transmission on a serving cell, the UE does not transmit the SRS in the overlapping symbol(s).

For a UE configured with one or more SRS resource configuration(s), and when the higher layer parameter resourceType in SRS-Resource is set to ‘periodic’:
if the UE is configured with the higher layer parameter spatialRelationInfo containing the ID of a reference ‘ssb-Index’, the UE shall transmit the target SRS resource with the same spatial domain transmission filter used for the reception of the reference SS/PBCH block; if the higher layer parameter spatialRelationInfo contains the ID of a reference ‘csi-RS-Index’, the UE shall transmit the target SRS resource with the same spatial domain transmission filter used for the reception of the reference periodic CSI-RS or of the reference SP CSI-RS; if the higher layer parameter spatialRelationInfo containing the ID of a reference ‘srs’, the UE shall transmit the target SRS resource with the same spatial domain transmission filter used for the transmission of the reference periodic SRS. When the SRS is configured by the higher layer parameter associated with SRS at least for positioning and if the higher layer parameter spatialRelationInfo contains the ID of a reference ‘DL-PRS-ResourceId’, the UE shall transmit the target SRS resource with the same spatial domain transmission filter used for the reception of the reference DL PRS.

For a UE configured with one or more SRS resource configuration(s), and when the higher layer parameter resourceType in SRS-Resource is set to ‘SP’:
when a UE receives an activation command, as described in TS 38.321, for an SRS resource, and when the UE may transmit a PUCCH with HARQ-ACK information in slot n corresponding to the PDSCH carrying the activation command is transmitted in slot n, the corresponding actions in TS 38.321 and the UE assumptions on SRS transmission corresponding to the configured SRS resource set shall be applied starting from the first slot that is after slot n+3Nₛₗₒₜ^{subframe,μ} where μ is the SCS configuration for the PUCCH. The activation command also contains spatial relation assumptions provided by a list of references to reference signal IDs, one per element of the activated SRS resource set. Each ID in the list refers to a reference SS/PBCH block, NZP CSI-RS resource configured on serving cell indicated by Resource Serving Cell ID field in the activation command if present, same serving cell as the SRS resource set otherwise, or SRS resource configured on serving cell and uplink bandwidth part indicated by Resource Serving Cell ID field and Resource BWP ID field in the activation command if present, same serving cell and BWP as the SRS resource set otherwise. When the SRS is configured with the higher layer parameter associated with SRS at least for positioning, each ID in the list of reference signal IDs may also refer to a reference SS/PBCH block of a non-serving cell or DL PRS of a serving or non-serving cell indicated by a higher layer parameter.
if an SRS resource in the activated resource set is configured with the higher layer parameter spatialRelationInfo, the UE shall assume that the ID of the reference signal in the activation command overrides the one configured in spatialRelationInfo.
when a UE receives a deactivation command, as introduced in TS 38.321, for an activated SRS resource set, and when the UE would transmit a PUCCH with HARQ-ACK information in slot n corresponding to the PDSCH carrying the deactivation command, the corresponding actions, as introduced in TS 38.321, and UE assumption on cessation of SRS transmission corresponding to the deactivated SRS resource set shall apply starting from the first slot that is after slot n+3Nₛₗₒₜ^{subframe,μ} where μ is the SCS configuration for the PUCCH.
if the UE is configured with the higher layer parameter spatialRelationInfo containing the ID of a reference ‘ssb-Index’, the UE shall transmit the target SRS resource with the same spatial domain transmission filter used for the reception of the reference SS/PBCH block, if the higher layer parameter spatialRelationInfo contains the ID of a reference ‘csi-RS-Index’, the UE shall transmit the target SRS resource with the same spatial domain transmission filter used for the reception of the reference periodic CSI-RS or of the reference SP CSI-RS, if the higher layer parameter spatialRelationInfo contains the ID of a reference ‘srs’, the UE shall transmit the target SRS resource with the same spatial domain transmission filter used for the transmission of the reference periodic SRS or of the reference SP SRS. When the SRS is configured by the higher layer parameter associated with SRS at least for positioning and if the higher layer parameter spatialRelationInfo contains the ID of a reference ‘DL-PRS-ResourceId’, the UE shall transmit the target SRS resource with the same spatial domain transmission filter used for the reception of the reference DL PRS.

If the UE has an active SP SRS resource configuration and has not received a deactivation command, the SP SRS configuration is considered to be active in the UL BWP which is active, otherwise it is considered suspended.

For a UE configured with one or more SRS resource configuration(s), and when the higher layer parameter resourceType in SRS-Resource is set to ‘AP’:
the UE receives a configuration of SRS resource sets,
the UE receives a DL DCI, a group common DCI, or a UL DCI based command where a codepoint of the DCI may trigger one or more SRS resource set(s). For SRS in a resource set with usage set to ‘codebook’ or ‘antennaSwitching’, the minimal time interval between the last symbol of the PDCCH triggering the AP SRS transmission and the first symbol of SRS resource is N₂. Otherwise, the minimal time interval between the last symbol of the PDCCH triggering the AP SRS transmission and the first symbol of SRS resource is N2+14. The minimal time interval in units of OFDM symbols is counted based on the minimum subcarrier spacing between the PDCCH and the AP SRS.
If the UE receives the DCI triggering AP SRS in slot n and except when SRS is configured with the higher layer parameter associated with SRS at least for positioning, the UE transmits AP SRS in each of the triggered SRS resource set(s) in slot

$$⌊ n \cdot \frac{{2}^{{μ}_{SRS}}}{{2}^{{μ}_{PDCCH}}} ⌋ + k + ⌊ ( \frac{{N}_{slot , offset , PDCCH}^{CA}}{{2}^{{μ}_{offset , PDCCH}}} - \frac{{N}_{slot , offset , SRS}^{CA}}{{2}^{{μ}_{offset , SRS}}} ) \cdot {2}^{{μ}_{SRS}} ⌋ ,$$

if UE is configured with CA-slot-offset for at least one of the triggered and triggering cell,

$${K}_{s} = ⌊ n \frac{{2}^{{μ}_{S R S}}}{{2}^{{μ}_{P D C C H}}} ⌋ + k ,$$

otherwise, and where
k is configured via higher layer parameter slotOffset for each triggered SRS resources set and is based on the subcarrier spacing of the triggered SRS transmission, μ_{SRS} and μ_{PDCCH} are the subcarrier spacing configurations for triggered SRS and PDCCH carrying the triggering command respectively;
N_{slot,offset,PDCCH}^{CA} and μ_{offset,PDCCH} are the N_{slot,offset}^{CA} and the μ_{offset}, respectively, which are determined by higher-layer configured CA-slot-offset for the cell receiving the PDCCH, N_{slot,offset,SRS}^{CA} and μ_{offset,SRS} are the N_{slot,offset}^{CA} and the μ_{offset}, respectively, which are determined by higher-layer configured CA-slot-offset for the cell transmitting the SRS, as defined in TS 38.211.
If the UE receives the DCI triggering AP SRS in slot n and when SRS is configured with the higher layer parameter associated with SRS at least for positioning, the UE transmits every AP SRS resource in each of the triggered SRS resource set(s) in slot

$$⌊ n \cdot \frac{{2}^{{μ}_{SRS}}}{{2}^{{μ}_{PDCCH}}} ⌋ + k + ⌊ ( \frac{{N}_{slot , offset , PDCCH}^{CA}}{{2}^{{μ}_{offset , PDCCH}}} - \frac{{N}_{slot , offset , SRS}^{CA}}{{2}^{{μ}_{offset , SRS}}} ) \cdot {2}^{{μ}_{SRS}} ⌋ ,$$

where:
k is configured via higher layer parameter slotOffset for each AP SRS resource in each triggered SRS resources set and is based on the subcarrier spacing of the triggered SRS transmission, μ_{SRS} and μ_{PDCCH} are the subcarrier spacing configurations for triggered SRS and PDCCH carrying the triggering command respectively;
N_{slot,offset}^{CA} offset and the μ_{offset} for the {scheduling, scheduled} carrier pair is defined in TS 38.211.
if the UE is configured with the higher layer parameter spatialRelationInfo containing the ID of a reference ‘ssb-Index’, the UE shall transmit the target SRS resource with the same spatial domain transmission filter used for the reception of the reference SS/PBCH block, if the higher layer parameter spatialRelationInfo contains the ID of a reference ‘csi-RS-Index’, the UE shall transmit the target SRS resource with the same spatial domain transmission filter used for the reception of the reference periodic CSI-RS or of the reference SP CSI-RS, or of the latest reference AP CSI-RS. If the higher layer parameter spatialRelationInfo contains the ID of a reference ‘srs’, the UE shall transmit the target SRS resource with the same spatial domain transmission filter used for the transmission of the reference periodic SRS or of the reference SP SRS or of the reference AP SRS. When the SRS is configured by the higher layer parameter associated with SRS at least for positioning and if the higher layer parameter spatialRelationInfo contains the ID of a reference ‘DL-PRS-ResourceId’, the UE shall transmit the target SRS resource with the same spatial domain transmission filter used for the reception of the reference DL PRS.
when a UE receives an spatial relation update command, as described in TS 38.321, for an SRS resource, and when the HARQ-ACK corresponding to the PDSCH carrying the update command is transmitted in slot n, the corresponding actions, as introduced in TS 38.321, and the UE assumptions on updating spatial relation for the SRS resource shall be applied for SRS transmission starting from the first slot that is after slot n+3Nₛₗₒₜ^{subframe,μ}. (The update command contains spatial relation assumptions provided by a list of references to reference signal IDs, one per element of the updated SRS resource set. Each ID in the list refers to a reference SS/PBCH block, NZP CSI-RS resource configured on serving cell indicated by Resource Serving Cell ID field in the update command if present, same serving cell as the SRS resource set otherwise, or SRS resource configured on serving cell and UL BWP indicated by Resource Serving Cell ID field and Resource BWP ID field in the update command if present, same serving cell and bandwidth part as the SRS resource set otherwise.) When the UE is configured with the higher layer parameter usage in SRS-ResourceSet set to ‘antennaSwitching’, the UE shall not expect to be configured with different spatial relations for SRS resources in the same SRS resource set.

The UE is not expected to be configured with different time domain behaviour for SRS resources in the same SRS resource set. The UE is also not expected to be configured with different time domain behaviour between SRS resource and associated SRS resources set.

For single carrier operations, the UE does not expect to be configured on overlapping symbols with a SRS resource configured by the higher layer parameter associated with SRS at least for positioning and a SRS resource configured by the higher layer parameter SRS-Resource with resourceType of both SRS resources as ‘periodic’.

For single carrier operations, the UE does not expect to be triggered to transmit SRS on overlapping symbols with a SRS resource configured by the higher layer parameter associated with SRS at least for positioning and a SRS resource configured by the higher layer parameter SRS-Resource with resourceType of both SRS resources as ‘SP’ or ‘AP.

The SRS request field (as introduced in TS 38.212) in DCI format 0_1, 1_1, 0_2 (if SRS request field is present), 1_2 (if SRS request field is present) indicates the triggered SRS resource set given in TS 38.212. The 2-bit SRS request field (as introduced in TS 38.212) in DCI format 2_3 indicates the triggered SRS resource set, as described in TS 38.212, if the UE is configured with higher layer parameter srs-TPC-PDCCH-Group set to ‘typeB’, or indicates the SRS transmission on a set of serving cells configured by higher layers if the UE is configured with higher layer parameter srs-TPC-PDCCH-Group set to ‘typeA’.

For PUCCH and SRS on the same carrier, a UE shall not transmit SRS when SP and periodic SRS are configured in the same symbol(s) with PUCCH carrying only CSI report(s), or only L1-RSRP report(s), or only L1-SINR report(s). A UE shall not transmit SRS when SP or periodic SRS is configured or AP SRS is triggered to be transmitted in the same symbol(s) with PUCCH carrying HARQ-ACK, link recovery request, as defined in TS 38.213) and/or SR. In the case that SRS is not transmitted due to overlap with PUCCH, only the SRS symbol(s) that overlap with PUCCH symbol(s) are dropped. PUCCH shall not be transmitted when AP SRS is triggered to be transmitted to overlap in the same symbol with PUCCH carrying SP/periodic CSI report(s) or SP/periodic L1-RSRP report(s) only, or only L1-SINR report(s).

In case of intra-band carrier aggregation or in inter-band CA band-band combination where simultaneous SRS and PUCCH/PUSCH transmissions are not allowed, a UE is not expected to be configured with SRS from a carrier and PUSCH/UL DMRS/UL PTRS/PUCCH formats from a different carrier in the same symbol.

In case of intra-band CA or in inter-band CA band-band combination where simultaneous SRS and PRACH transmissions are not allowed, a UE shall not transmit simultaneously SRS resource(s) from a carrier and PRACH from a different carrier.

In case an SRS resource with resourceType set as ‘AP’ is triggered on the OFDM symbol(s) configured with periodic/SP SRS transmission, the UE shall transmit the AP SRS resource and only the periodic/SP SRS symbol(s) overlapping within the symbol(s) are dropped, while the periodic/SP SRS symbol(s) that are not overlapped with the AP SRS resource are transmitted. In case an SRS resource with resourceType set as ‘SP’ is triggered on the OFDM symbol(s) configured with periodic SRS transmission, the UE shall transmit the SP SRS resource and only the periodic SRS symbol(s) overlapping within the symbol(s) are dropped, while the periodic SRS symbol(s) that are not overlapped with the SP SRS resource are transmitted.

When the UE is configured with the higher layer parameter usage in the SRS-ResourceSet set to ‘antennaSwitching’, and a guard period of Y symbols is configured, the UE shall use the same priority rules as defined above during the guard period as if SRS was configured.

When a spatialRelationInfo is activated/updated for a SP or AP SRS resource configured by the higher layer parameter SRS-Resource by a MAC CE for a set of CCs/BWPs, where the applicable list of CCs is indicated by higher layer parameter indicating an applicable cell list, the spatialRelationInfo is applied for the SP or AP SRS resource(s) with the same SRS resource ID for all the BWPs in the indicated CCs.

When the higher layer parameter enableDefaultBeamPlForSRS is set to ‘enabled’, and if the higher layer parameter spatialRelationInfo for the SRS resource, except for the SRS resource with the higher layer parameter usage in SRS-ResourceSet is set to ‘beamManagement’ or for the SRS resource with the higher layer parameter usage in SRS-ResourceSet is set to ‘nonCodebook’ with a configuration of associatedCSl-RS or for the SRS resource configured by the higher layer parameter associated with SRS at least for positioning, is not configured in FR2 and if the UE is not configured with higher layer parameter(s) pathlossReferenceRS, the UE shall transmit the target SRS resource:
with the same spatial domain transmission filter used for the reception of the CORESET with the lowest controlResourceSetld in the active DL BWP in the CC;
with the same spatial domain transmission filter used for the reception of the activated TCI state with the lowest ID applicable to PDSCH in the active DL BWP of the CC if the UE is not configured with any CORESET in the CC.

Furthermore, some or all of the following terminology and assumption may be used hereinafter:
BS: a NW central unit or a NW node in NR which is used to control one or multiple TRPs which are associated with one or multiple cells. Communication between BS and TRP(s) is via fronthaul. The BS may be referred to as central unit (CU), eNB, gNB, or NodeB.
TRP: a TRP provides NW coverage and directly communicates with UEs. The TRP may be referred to as distributed unit (DU) or NW node.
Cell: a cell is composed of one or multiple associated TRPs, i.e. coverage of the cell is composed of coverage of all associated TRP(s). One cell is controlled by one BS. The Cell may be referred to as TRP group (TRPG).
Serving beam: serving beam for a UE is a beam generated by a NW node, e.g. TRP, which is configured to be used to communicate with the UE, e.g. for transmission and/or reception.
Candidate beam: candidate beam for a UE is a candidate of a serving beam. The Serving beam may or may not be candidate beam.
EDT: this allows one UL data transmission optionally followed by one DL data transmission during the RA procedure as specified in TS 36.300. The Si connection is established or resumed upon reception of the UL data and may be released or suspended along with the transmission of the DL data. The EDT refers to both control plane-EDT and user plane-EDT.
Transmission using a PUR: this allows one UL data transmission using the PUR from RRC_IDLE mode as specified in TS 36.300. Transmission using PUR refers to both CP transmission using PUR and UL transmission using PUR.

5G/NR has been continuously developed. In NR Release 16, one MAC-CE is supported to indicate/update a UL beam or spatial relation for one or more AP SRS(s). This MAC-CE is also able to achieve the same effect for SP SRS(s). This MAC-CE by default provides UL beam related information for all SRS resource(s) within an AP/SP SRS resource set indicated by the MAC-CE. It is observed that many octets can be consumed for each SRS resource(s) in an indicated SRS resource set. For example, a maximum of 16 SRS resources currently can be included in an SRS resource set.

Therefore, the present disclosure is related to optimization or modification on the MAC-CE, which may be achieved to save some signaling overhead at least under some conditions (e.g., when the MAC-CE deactivates indicated SRS resource set). Other methods or aspects may be also considered to avoid unnecessary signaling overhead, which results from indicating UL beams for each SRS resource in indicated SRS resource set.

The ideas, concepts and embodiments throughout the present disclosure may be used to solve the above-mentioned issues. The ideas, concepts and embodiments throughout the present disclosure may also be used for similar issues in order that saving or avoiding signaling overhead when indicating a signal. More specifically, the present disclosure may be also applicable for a signal (e.g., DCI, MAC-CE or RRC signal) used for purposes other than an SRS resource. For example, the present disclosure may be applied for a MAC-CE indicating DL beams for a DL RS (set) or a DL channel.

In some implementations, for a MAC-CE indicating a UL beam for an AP/SP SRS, when it is used for deactivating an SP SRS, field(s) related to UL beam indications may be absent or ignored.

Specifically, a UE may receive a MAC-CE indicating spatial relation(s) for one or more SRS resource(s). The MAC-CE may indicate a SRS resource set containing the one or more SRS resource(s). For example, the UE may be configured with a first SRS resource set; the UE may be configured with a second SRS resource set. The SRS resource set indicated by the MAC-CE may be either one of the first SRS resource set and the second SRS resource set.

The MAC-CE may activate or deactivate a SRS resource set indicated by the MAC-CE. The MAC-CE may activate or deactivate an SRS resource set indicated by the MAC-CE, where the SRS resource set may be or must be SP.

The MAC-CE may include one or more first fields indicating spatial relation(s). For example, the first field may indicate spatial relation via an Identification (ID) (of a resource or a reference signal or an SSB); the MAC-CE may include one or more second fields corresponding to the one or more first fields. The second field may indicate the type of reference signal associated with the indicated spatial relation(s) from the first field. Each of the indicated spatial relations from the one or more first fields may apply for the one or more corresponding SRS resources.

The one or more first fields and/or the one or more second fields may not be present (i.e., be absent) or may not be allowed to be present when (or if) the MAC-CE indicates the second SRS resource set and the MAC-CE deactivates the second SRS resource set.

The one or more first fields and/or the one or more second fields may be not present (i.e., be absent) or may not be allowed to be present, where the MAC-CE indicates the second SRS resource set and the MAC-CE deactivates the second SRS resource set.

The UE may ignore, discard, or may not use the one or more first fields and/or the one or more second fields when (or if) the MAC-CE indicates that the second SRS resource set and the MAC-CE deactivates the second SRS resource set.

The UE may ignore, discard, or may not use the one or more first fields and/or the one or more second fields, where the MAC-CE indicates the second SRS resource set and the MAC-CE deactivates the second SRS resource set.

The one or more first fields and/or the one or more second fields may be Reservation fields/bits when (or if) the MAC-CE indicates the second SRS resource set and the MAC-CE deactivates the second SRS resource set.

The one or more first fields and/or the one or more second fields may be Reservation fields/bits, where the MAC-CE indicates the second SRS resource set and the MAC-CE deactivates the second SRS resource set.

In some implementations, the one or more first fields and/or the one or more second fields may be (required to be) present when (or if) at least one of the following conditions is satisfied:
the MAC-CE indicates the first SRS resource set; and
the MAC-CE indicates the second SRS resource set and the MAC-CE activates the second SRS resource set.

In some implementations, the one or more first fields and/or the one or more second fields may be (required to be) present, where at least one of the following conditions is satisfied:
the MAC-CE indicates the first SRS resource set; and
the MAC-CE indicates the second SRS resource set and the MAC-CE activates the second SRS resource set.

In some implementations, the first SRS resource set may be an AP SRS resource set; the second SRS resource set may be a SP SRS resource set.

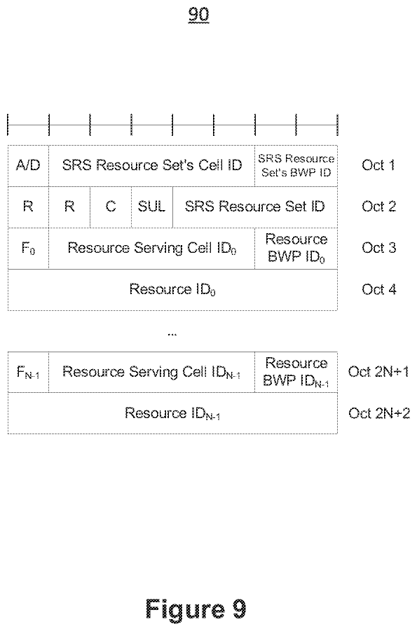

Please refer to FIG. 9, which illustrates an overview of the MAC-CE 90 according to an example implementation of the present disclosure. As shown in FIG. 9, for example, the MAC-CE 90 may be an Enhanced SP/AP SRS Spatial Relation Indication MAC CE, where the one or more first fields may be Resource ID field and the one or more second fields may be an F field.

In some implementations, there may be two types of MAC-CE, which may both be used to indicate a UL beam for SP SRS. Both types of MAC-CE may be used to activate SP SRS, and only one type of MAC-CE may be used to deactivate SP SRS.

Specifically, a UE may receive at least one first MAC-CE indicating spatial relation(s) for one or more SRS resource. The first MAC-CE may indicate a SRS resource set containing the one or more SRS resources. The UE may receive at least one second MAC-CE indicating spatial relation(s) for one or more SRS resources. The second MAC-CE may indicate a SRS resource set containing the one or more SRS resources. For example, the UE may be configured with a first SRS resource set; also, the UE may be configured with a second SRS resource set. The SRS resource set indicated by the first MAC-CE may be the first SRS resource set or the second SRS resource set. The SRS resource set indicated by the second MAC-CE may be or must be the second SRS resource set.

The first MAC-CE may activate the second SRS resource set. The first MAC-CE may not be used to deactivate the second SRS resource set. The first MAC-CE may not be used to (allowed to) deactivate the second SRS resource set, where the first MAC-CE provides functionality of deactivating a SRS resource set.

The second MAC-CE may be used to at least activate or deactivate the second SRS resource set. The second MAC-CE may be used to deactivate the second SRS resource set, which is previously activated by the first MAC-CE.

In some implementations, the first SRS resource set may be an AP SRS resource set; the second SRS resource set may be a SP SRS resource set.

For example, the first MAC-CE may be an Enhanced SP/AP SRS Spatial Relation Indication MAC CE; the second MAC-CE may be a SP SRS Activation/Deactivation MAC CE.

Any combination of the previous disclosure may be jointly combined or formed to be a new implementation; alternatively, any combination of the previous disclosure may also be generalized to form a new implementation. The following disclosure can be used to solve at least, but not limited to, the above issue.

In some implementations, a UE is configured with and/or served in a specific serving cell by a NW. The UE may be configured with one or more serving cells, which may include the specific serving cell. The UE may be activated in or be indicated to activate one or more serving cells, which may include the specific serving cell. The UE may be configured and/or indicated in one or more BWP. The UE may be indicated and/or activated in a (active) BWP. Preferably, the UE may be indicated/activated in an active DL BWP, an active UL BWP, an initial BWP, a default BWP and/or a dormant BWP. Preferably, the active DL BWP may be in the specific serving cell, and the active UL BWP may be in the specific serving cell. Preferably, the UE may be in an RRC_CONNECTED state, an RRC_INACTIVE state, or an RRC_IDLE state. Preferably, the UE may be configured with a first SRS resource set and/or a second SRS resource set. Preferably, the first SRS resource set may be configured in the active (UL) BWP, and the second SRS resource set may be configured in the active (UL) BWP.

Preferably, the first SRS resource set may be (configured as) an AP SRS resource set, an SP SRS resource set or a periodic SRS resource set. Preferably, one or more SRS resources included in or associated with the first SRS resource set may be (configured as) AP SRS resources, SP SRS resources or periodic SRS resources.

Preferably, the second SRS resource set may be (configured as) an SP SRS resource set, an AP SRS resource set or a periodic SRS resource set. Preferably, one or more SRS resources included in or associated with the second SRS resource set may be (configured as) SP SRS resources, AP SRS resources or periodic SRS resources.

Preferably, the UE may receive a first MAC-CE. The first MAC-CE may indicate a SRS resource set. The first MAC-CE may activate/deactivate an SRS resource set (indicated in the first MAC-CE). One or more SRS resource may be included in or associated with the SRS resource set indicated in the first MAC-CE. Preferably, the SRS resource set indicated in the first MAC-CE may be the first SRS resource set or the second SRS resource set. Preferably, the first MAC-CE may indicate information corresponding to the one or more SRS resources included in or associated with the SRS resource set indicated in the first MAC-CE. Preferably, the first MAC-CE may activate/deactivate the one or more SRS resources included in or associated with the SRS resource set indicated in the first MAC-CE. Preferably, the first MAC-CE may activate/deactivate the SRS resource set indicated in the first MAC-CE (only) when (or if) the SRS resource set is the second SRS resource set. Preferably, the first MAC-CE may activate/deactivate the SRS resource set indicated in the first MAC-CE, where the SRS resource set is the second SRS resource set. Preferably, the first MAC-CE may further comprise or carry a third field and/or a fourth field.

Preferably, the UE may receive a second MAC-CE. Preferably, the second MAC-CE may indicate an SRS resource set. Preferably, the second MAC-CE may activate an SRS resource set (indicated in the second MAC-CE). Preferably, the second MAC-CE may deactivate an SRS resource set (indicated in the second MAC-CE). Preferably, one or more SRS resource may be included in or associated with the SRS resource set indicated in the second MAC-CE. Preferably, the SRS resource set indicated in the second MAC-CE may be or must be the second SRS resource set. Preferably, the second MAC-CE may indicate information corresponding to one or more SRS resource(s) included in or associated with the SRS resource set indicated in the second MAC-CE. Preferably, the second MAC-CE may activate the one or more SRS resource(s) included in or associated with the SRS resource set indicated in the second MAC-CE. Preferably, the second MAC-CE may deactivate the one or more SRS resource(s) included in or associated with the SRS resource set indicated in the second MAC-CE. Preferably, the second MAC-CE may comprise or carry a third field. Preferably, the second MAC-CE may comprise or carry a fourth field.

Preferably, the indicated information for an SRS resource may be associated with information of a UL beam for transmitting the SRS resource. Preferably, the indicated information for the SRS resource may comprise one or more first field and/or one or more second field. Preferably, one first field may correspond to or map one-to-one to one second field.

Preferably, the first field may indicate a UL beam for transmitting an SRS resource. Preferably, the first field may indicate an index of a resource. Preferably, the first field may indicate an index of a resource, where the UE may derive, from the index of a resource, the spatial relation for transmitting the SRS resource or derive how to transmit the SRS resource. Preferably, the second field may indicate or be used to provide the type of the resource indicated in corresponding first field. Preferably, the second field may indicate or be used to provide the type of the resource indicated in the corresponding first field, where the type may be one of the following:
a (NZP) CSI-RS;
an SSB;
an SRS;
a Position DL RS; and
a Position UL RS.

Preferably, the third field may indicate whether to activate/deactivate an SRS resource set indicated in a MAC-CE. Preferably, the fourth field may indicate whether the serving cell (ID) and/or BWP (ID) of resource(s) indicated in the one or more first fields are identical to the serving cell (ID) and/or the BWP (ID) of the indicated SRS resource set.

Preferably, the first MAC-CE may be an Enhanced SP/AP SRS Spatial Relation Indication MAC CE. Preferably, the first MAC-CE may be an SP Positioning SRS Activation/Deactivation MAC CE; the second MAC-CE may be an SP SRS Activation/Deactivation MAC CE. Preferably, the first field may be a “Resource ID” field or a “Spatial Relation for Resource ID” field. Preferably, the second field may be an “F” field, an “F0” field or an “F1” field. Preferably, the second field may comprise or include an “F0” field and an “F1” field. Preferably, the third field may be an “A/D” field. Preferably, the fourth field may be a “C” field.

In some implementations, the one or more first fields in the first MAC-CE may be absent or may not be allowed to be present, and the one or more second fields in the first MAC-CE may be absent or may not be allowed to be present. Preferably, the one or more first fields in the first MAC-CE may be absent or may not be allowed to be present when (or if) the first MAC-CE indicates the second SRS resource set and the first MAC-CE deactivates the second SRS resource set. Preferably, the one or more first fields in the first MAC-CE may be absent or may not be allowed to be present, where the first MAC-CE indicates the second SRS resource set and the first MAC-CE deactivates the second SRS resource set. Preferably, the one or more second fields in the first MAC-CE may be absent or may not be allowed to be present when (or if) the first MAC-CE indicates the second SRS resource set and the first MAC-CE deactivates the second SRS resource set. Preferably, the one or more second fields in the first MAC-CE may be absent or may not be allowed to be present, where the first MAC-CE indicates the second SRS resource set and the first MAC-CE deactivates the second SRS resource set. Preferably, the UE may ignore/discard or may not use the one or more first/second fields. Preferably, the UE may ignore/discard or may not use the one or more first fields when (or if) the first MAC-CE indicates the second SRS resource set and the first MAC-CE deactivates the second SRS resource set. Preferably, the UE may ignore/discard or may not use the one or more first fields, where the first MAC-CE indicates the second SRS resource set and the first MAC-CE deactivates the second SRS resource set. Preferably, the UE may ignore discard or may not use the one or more second fields when (or if) the first MAC-CE indicates the second SRS resource set and the first MAC-CE deactivates the second SRS resource set. Preferably, the UE may ignore/discard or may not use the one or more second fields, where the first MAC-CE indicates the second SRS resource set and the first MAC-CE deactivates the second SRS resource set.

Preferably, the one or more first fields or the one or more second fields in the first MAC-CE may be Reservation fields/bits. Preferably, the one or more first fields in the first MAC-CE may be Reservation fields/bits when (or if) the first MAC-CE indicates the second SRS resource set and the first MAC-CE deactivates the second SRS resource set. Preferably, the one or more first fields in the first MAC-CE may be Reservation fields/bits, where the first MAC-CE indicates the second SRS resource set and the first MAC-CE deactivates the second SRS resource set. Preferably, the one or more second fields in the first MAC-CE may be Reservation fields/bits when (or if) the first MAC-CE indicates the second SRS resource set and the first MAC-CE deactivates the second SRS resource set. Preferably, the one or more second fields in the first MAC-CE may be Reservation fields/bits, where the first MAC-CE indicates the second SRS resource set and the first MAC-CE deactivates the second SRS resource set. Preferably, the one or more first fields in the first MAC-CE may (be required to) be present; and the one or more second fields in the first MAC-CE may (be required to) be present.

Preferably, the one or more first fields in the first MAC-CE may (be required to) be present when (or if) one of the following conditions is satisfied:
the first MAC-CE indicates the first SRS resource set; and
the first MAC-CE indicates the second SRS resource set and the first MAC-CE activates the second SRS resource set.

Preferably, the one or more first fields in the first MAC-CE may (be required to) be present, where one of the following conditions is satisfied:
the first MAC-CE indicates the first SRS resource set; and
the first MAC-CE indicates the second SRS resource set and the first MAC-CE activates the second SRS resource set.

Preferably, the one or more second fields in the first MAC-CE may (be required to) be present when (or if) one of the following conditions is satisfied:
the first MAC-CE indicates the first SRS resource set; and
the first MAC-CE indicates the second SRS resource set and the first MAC-CE activates the second SRS resource set

Preferably, the one or more second fields in the first MAC-CE may (be required to) be present, where one of the following conditions is satisfied:
the first MAC-CE indicates the first SRS resource set; and
the first MAC-CE indicates the second SRS resource set and the first MAC-CE activates the second SRS resource set.

In some implementations, the fourth field in the first MAC-CE may indicate the serving cell (ID) and/or BWP ID of resources indicated in the one or more first fields are identical to the serving cell (ID) and/or BWP ID of the second SRS resource set, when (or if) the first MAC-CE indicates the second SRS resource set and the first MAC-CE deactivates the second SRS resource set. Preferably, the fourth field in the first MAC-CE may indicate the serving cell (ID) and/or BWP ID of resource(s) indicated in the one or more first fields are identical to the serving cell (ID) and/or BWP ID of the second SRS resource set, where the first MAC-CE indicates the second SRS resource set and the first MAC-CE deactivates the second SRS resource set.

Preferably, one or more fields to indicate serving cell (ID) of resource(s) indicated in the one or more first fields may not (be allowed to) be present or may be Reservation fields/bits in the first MAC-CE when (or if) the first MAC-CE indicates the second SRS resource set and the first MAC-CE deactivates the second SRS resource set. Preferably, one or more fields to indicate serving cell (ID) of resource(s) indicated in the one or more first fields may not (be allowed to) be present or may be Reservation fields/bits in the first MAC-CE, where the first MAC-CE indicates the second SRS resource set and the first MAC-CE deactivates the second SRS resource set.

Preferably, one or more fields to indicate BWP (ID) of resource(s) indicated in the one or more first fields may not (be allowed to) be present or may be Reservation fields/bits in the first MAC-CE when (or if) the first MAC-CE indicates the second SRS resource set and the first MAC-CE deactivates the second SRS resource set. Preferably, one or more fields to indicate BWP (ID) of resource(s) indicated in the one or more first fields may not (be allowed to) be present or may be Reservation fields/bits in the first MAC-CE, where the first MAC-CE indicates the second SRS resource set and the first MAC-CE deactivates the second SRS resource set.

Preferably, the UE may ignore or may not use one or more fields to indicate the serving cell (ID) of resource(s) indicated in the one or more first fields when (or if) the first MAC-CE indicates the second SRS resource set and the first MAC-CE deactivates the second SRS resource set. Preferably, the UE may ignore or may not use one or more fields to indicate the serving cell (ID) of resource(s) indicated in the one or more first fields, where the first MAC-CE indicates the second SRS resource set and the first MAC-CE deactivates the second SRS resource set.

Preferably, the UE may ignore or may not use one or more fields to indicate BWP (ID) of resource(s) indicated in the one or more first fields when (or if) the first MAC-CE indicates the second SRS resource set and the first MAC-CE deactivates the second SRS resource set. Preferably, the UE may ignore or may not use one or more fields to indicate BWP (ID) of resource(s) indicated in the one or more first fields, where the first MAC-CE indicates the second SRS resource set and the first MAC-CE deactivates the second SRS resource set.

In some implementations, the first MAC-CE may (only) be used to activate the second SRS resource set. Preferably, the first MAC-CE may not (be allowed to) be used to deactivate the second SRS resource set. Preferably, the first MAC-CE may not (be allowed to) be used to deactivate the second SRS resource set, where the first MAC-CE provides functionality of deactivating the second SRS resource set. Preferably, the UE may not expect to receive the first MAC-CE to deactivate the second SRS resource set.

Preferably, the NW may not (be allowed to) deactivate the second SRS resource set by sending the first MAC-CE to the UE. Preferably, the NW may be prevented from sending the first MAC-CE to the UE for deactivating the second SRS resource set.

Preferably, the UE may activate the second SRS resource set when (or if) the UE receives the first MAC-CE and the first MAC-CE indicates the second SRS resource set. Preferably, the UE may activate the second SRS resource set, where the UE receives the first MAC-CE and the first MAC-CE indicates the second SRS resource set. Preferably, the UE may activate the second SRS resource set without one field in the first MAC-CE to indicate such activation when (or if) the UE receives the first MAC-CE and the first MAC-CE indicates the second SRS resource set. Preferably, the UE may activate the second SRS resource set without one field in the first MAC-CE to indicate such activation, where the UE receives the first MAC-CE and the first MAC-CE indicates the second SRS resource set.

Preferably, the third field may not be present in the first MAC-CE when (or if) the SRS resource set indicated in the first MAC-CE is the second SRS resource set. Preferably, the third field may not be present in the first MAC-CE, where the SRS resource set indicated in the first MAC-CE is the second SRS resource set. Preferably, the UE may ignore or may not use the third field in the first MAC-CE when (or if) the SRS resource set indicated in the first MAC-CE is the second SRS resource set. Preferably, the UE may ignore or may not use the third field in the first MAC-CE, where the SRS resource set indicated in the first MAC-CE is the second SRS resource set. Preferably, the UE may ignore or may not use the third field in the first MAC-CE regardless of the SRS resource set indicated in the first MAC-CE.

Preferably, the third field may be set or seen as the Reservation field/bit in the first MAC-CE. Preferably, the third field may be set or seen as the Reservation field/bit in the first MAC-CE regardless of the SRS resource set indicated in the first MAC-CE.

Preferably, there is no field in the first MAC-CE to indicate such activation and/or deactivation. Preferably, the first MAC-CE may not comprise or carry the third field. Preferably, the second MAC-CE may be used to deactivate the second SRS resource set. Preferably, the second MAC-CE may be used to deactivate the second SRS resource set, where the second SRS resource set is previously activated by first MAC-CE.

Preferably, the NW may (only or be allowed to) deactivate the second SRS resource set via the second MAC-CE. Preferably, the NW may (only or be allowed to) deactivate the second SRS resource set via the second MAC-CE when (or after) the NW has activated the second SRS resource set via the first MAC-CE. Preferably, the NW may (only or be allowed to) deactivate the second SRS resource set via the second MAC-CE, where the NW has activated the second SRS resource set via the first MAC-CE.

It is noted that throughout the present disclosure, a UL beam for transmitting a UL resource (e.g., the SRS resource) may be referred to or replaced with at least one of the following:
a spatial relation;
a UL TCI;
a spatial filter;
a transmission precoder;
spatial parameters; and
a spatial relationship.

Also, the present disclosure is related to the advantageous effect of saving the signaling overhead when indicating the SRS-related information for the UE performing SRS resource transmission.

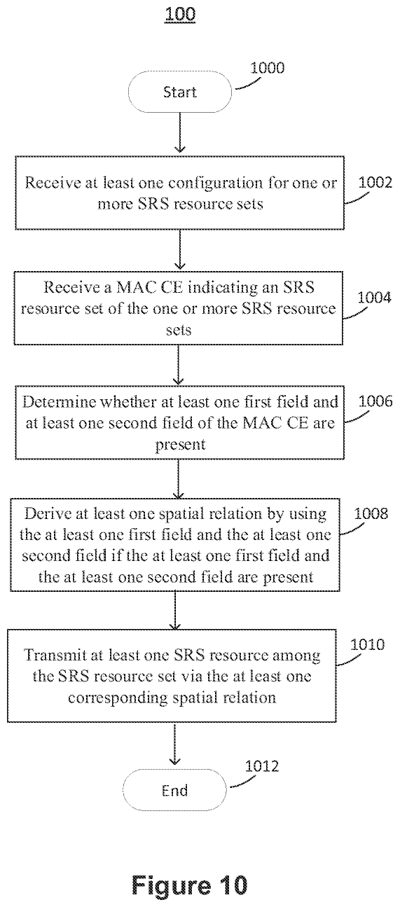

Please refer to FIG. 10, which illustrates a procedure 100 for SRS resource transmission performed by a UE according to an implementation of the present disclosure. As shown in FIG. 10, the procedure 100 for the UE includes the following actions:

Action 1000: Start.

Action 1002: Receive at least one configuration for one or more SRS resource sets.

Action 1004: Receive a MAC CE indicating an SRS resource set of the one or more SRS resource sets.

Action 1006: Determine whether at least one first field and at least one second field of the MAC CE are present.

Action 1008: Derive at least one spatial relation by using the at least one first field and the at least one second field if the at least one first field and the at least one second field are present.

Action 1010: Transmit at least one SRS resource among the SRS resource set via the at least one corresponding spatial relation.

Action 1012: End.

Preferably, action 1002 to action 1010 of the procedure 100 may be performed by the UE. In some implementations, the UE may receive at least one configuration that configures one or more SRS resource sets and receive the MAC CE indicating one SRS resource set from the one or more SRS resource sets in actions 1002 and 1004. In action 1006, the UE may determine whether the at least one first field and the at least one second field of the MAC CE are present. In action 1008, the UE may derive the at least one spatial relation by using the at least one first field and the at least one second field if the at least one first field and the at least one second field are present, where the UE may derive an N-th element of the at least one spatial relation by using both an N-th element of the at least one first field and an N-th element of the at least one second field. Specifically, the at least one first field and the at least one second field of the MAC CE are present at least when the SRS resource set is an AP SRS resource set. In action 1010, the UE may transmit the at least one SRS resource among the SRS resource set indicated by the MAC CE via the at least one corresponding spatial relation. The detailed mechanisms and/or operations (e.g., action 1002 to action 1010) of the procedure 100 are disclosed in above paragraphs and not disclosed here for brevity.

In some implementations, each of the at least one first field may indicate at least one resource index for deriving one spatial relation, and each of the at least one second field may indicate at least one resource type for deriving one spatial relation. Specifically, the at least one first field may refer to a resource ID field, and the at least one second field may refer to a F field.

In some implementations, a total number of the at least one SRS resource may be the same as a total number of the at least one spatial relation, a total number of the at least one SRS resource may be the same as a total number of the at least one first field, and a total number of the at least one SRS resource may be the same as a total number of the at least one second field.

Furthermore, the procedure 100 may further include other actions/procedures/mechanisms/operations.

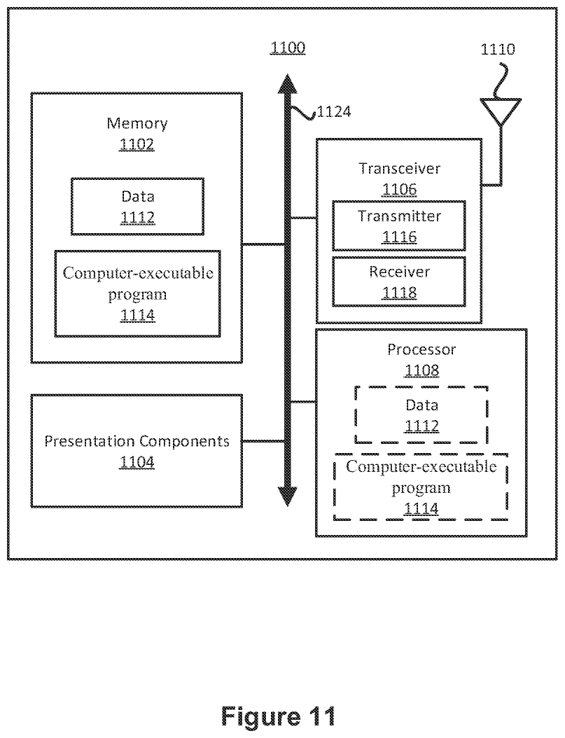

Please refer to FIG. 11, which illustrates a block diagram of a node 1100 for wireless communication according to an implementation of the present disclosure. As illustrated in FIG. 11, the node 1100 includes a transceiver 1106, a processor 1108, a memory 1102, one or more presentation components 1104, and at least one antenna 1110. The node 1100 may also include a Radio Frequency (RF) spectrum band module, a BS communications module, an NW communications module, and a system communications management module, input/output (I/O) ports, I/O components, and power supply (not explicitly illustrated in FIG. 11). Each of these components may be in communication with each other, directly or indirectly, over one or more buses 1124. The node 1100 may be a UE or a BS that performs various functions disclosed herein, for example, with reference to FIG. 10.

The transceiver 1106 includes a transmitter 1116 (e.g., transmitting/transmission circuitry) and a receiver 1118 (e.g., receiving/reception circuitry) and may be configured to transmit and/or receive time and/or frequency resource partitioning information. The transceiver 1106 may be configured to transmit in different types of subframes and slots, including, but not limited to, usable, non-usable and flexibly usable subframes and slot formats. The transceiver 1106 may be configured to receive data and control channels.

The node 1100 may include a variety of computer-readable media. Computer-readable media may be any available media that may be accessed by the node 1100 and include both volatile (and non-volatile) media and removable (and non-removable) media. By way of example, and not limitation, computer-readable media may include computer storage media and communication media. Computer storage media may include both volatile (and non-volatile) and removable (and non-removable) media implemented according to any method or technology for storage of information such as computer-readable.

Computer storage media includes RAM, ROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer storage media does not include a propagated data signal. Communication media may typically embody computer-readable instructions, data structures, program modules, or other data in a modulated data signal such as a carrier wave or other transport mechanism and include any information delivery media.

The term “modulated data signal” may refer to a signal that has one or more of its characteristics set or changed in such a manner as to encode information in the signal. By way of example, and not limitation, communication media may include wired media such as a wired NW or direct-wired connection, and wireless media such as acoustic, RF, infrared and other wireless media. Combinations of any of the previous disclosure should also be included within the scope of computer-readable media.

The memory 1102 may include computer-storage media in the form of volatile and/or non-volatile memory. The memory 1102 may be removable, non-removable, or a combination thereof. For example, the memory 1102 may include solid-state memory, hard drives, optical-disc drives, etc.

As illustrated in FIG. 11, the memory 1102 may store a computer-executable (or readable) program 1114 (e.g., software codes) that are configured to, when executed, cause the processor 1108 to perform various functions disclosed herein, for example, with reference to FIG. 11. Alternatively, the computer-executable program 1114 may not be directly executable by the processor 1108 but may be configured to cause the node 1100 (e.g., when compiled and executed) to perform various functions disclosed herein.

The processor 1108 (e.g., having processing circuitry) may include an intelligent hardware device, a Central Processing Unit (CPU), a microcontroller, an ASIC, etc. The processor 1108 may include memory. The processor 1108 may process the data 1112 and the computer-executable program 1114 received from the memory 1102, and information received via the transceiver 1106, the baseband communications module, and/or the NW communications module. The processor 1108 may also process information to be sent to the transceiver 1106 for transmission through the antenna 1110 to the NW communications module for subsequent transmission to a CN.

One or more presentation components 1104 may present data to a person or other device. Examples of presentation components 1104 may include a display device, speaker, printing component, vibrating component, etc.

From the present disclosure, it is manifested that various techniques may be used for implementing the disclosed concepts without departing from the scope of those concepts. Moreover, while the concepts have been disclosed with specific reference to certain implementations, a person of ordinary skill in the art would recognize that changes may be made in form and detail without departing from the scope of those concepts. As such, the disclosed implementations are to be considered in all respects as illustrative and not restrictive. It should also be understood that the present disclosure is not limited to the particular disclosed implementations. Many rearrangements, modifications, and substitutions are possible without departing from the scope of the present disclosure.

What is claimed is:

1. A method performed by a User Equipment (UE) for Sounding Reference Signal (SRS) resources, the method comprising:
receiving at least one configuration for one or more SRS resource sets;
receiving a Medium Access Control (MAC) Control Element (CE) indicating an SRS resource set of the one or more SRS resource sets;
determining whether at least one first field and at least one second field of the MAC CE are present;
deriving at least one spatial relation by using the at least one first field and the at least one second field if the at least one first field and the at least one second field are present; and
transmitting at least one SRS resource among the SRS resource set via the at least one corresponding spatial relation,
wherein the at least one first field and the at least one second field of the MAC CE are present at least when the SRS resource set is an aperiodic SRS resource set.

2. The method according to claim 1, wherein each of the at least one first field indicates at least one resource index for deriving one spatial relation.

3. The method according to claim 1, wherein each of the at least one second field indicates at least one resource type for deriving one spatial relation.

4. The method according to claim 1, wherein a total number of the at least one SRS resource is the same as a total number of the at least one spatial relation.

5. The method according to claim 1, wherein a total number of the at least one SRS resource is the same as a total number of the at least one first field.

6. The method according to claim 1, wherein a total number of the at least one SRS resource is the same as a total number of the at least one second field.

7. The method according to claim 1, further comprising:
deriving an N-th element of the at least one spatial relation by using both an N-th element of the at least one first field and an N-th element of the at least one second field.

8. The method according to claim 1, wherein the at least one first field refers to a resource Identity (ID) field.

9. The method according to claim 1, wherein the at least one second field refers to a F field.

10. A User Equipment (UE) in a wireless communication system for Sounding Reference Signal (SRS) resources, the UE comprising:
a processor; and
a memory coupled to the processor, wherein the memory stores a computer-executable program that when executed by the processor, causes the processor to:
receive at least one configuration for one or more SRS resource sets;
receive a Medium Access Control (MAC) Control Element (CE) indicating an SRS resource set of the one or more SRS resource sets;
determine whether at least one first field and at least one second field of the MAC CE are present;
derive at least one spatial relation by using the at least one first field and the at least one second field if the at least one first field and the at least one second field are present; and
transmit at least one SRS resource among the SRS resource set via the at least one corresponding spatial relation,
wherein the at least one first field and the at least one second field of the MAC CE are present at least when the SRS resource set is an aperiodic SRS resource set.

11. The UE according to claim 10, wherein each of the at least one first field indicates at least one resource index for deriving one spatial relation.

12. The UE according to claim 10, wherein each of the at least one second field indicates at least one resource type for deriving one spatial relation.

13. The UE according to claim 10, wherein a total number of the at least one SRS resource is the same as a total number of the at least one spatial relation.

14. The UE according to claim 10, wherein a total number of the at least one SRS resource is the same as a total number of the at least one first field.

15. The UE according to claim 10, wherein a total number of the at least one SRS resource is the same as a total number of the at least one second field.

16. The UE according to claim 10, wherein the processor when executed by the processor, further causes the processor to:
derive an N-th element of the at least one spatial relation by using both an N-th element of the at least one first field and an N-th element of the at least one second field.

17. The UE according to claim 10, wherein the at least one first field refers to a resource Identity (ID) field.

18. The UE according to claim 10, wherein the at least one second field refers to a F field.
